(19) United States
(12) Patent Application Publication
(10) Pub. No.: US 2024/0314657 A1
(43) Pub. Date: Sep. 19, 2024

(54) USER EQUIPMENT ACCESS TO AND MOBILITY BETWEEN NON-PUBLIC NETWORKS

(71) Applicant: QUALCOMM Incorporated, San Diego, CA (US)

(72) Inventors: Shankar Krishnan, San Diego, CA (US); Prasad Reddy Kadiri, San Diego, CA (US); Luis Fernando Brisson Lopes, Swindon (GB); Geetha Priya Rajendran, Bangalore (IN)

(21) Appl. No.: 18/184,544

(22) Filed: Mar. 15, 2023

(51) Int. Cl. H04W 36/14; H04W 36/00

(52) U.S. Cl. CPC H04W 36/14; H04W 36/0061; H04W 36/0069

(57) ABSTRACT

Aspects presented herein relate to methods and devices for wireless communication for facilitating user equipment access to, and mobility between, non-public networks. The disclosed techniques support idle or connected mode mobility between standalone non-public networks (SNPNs) without the need for selection of a new network. Further, the techniques provide support for non-3GPP access for SNPNs as well as provide access to localized services related to non-public networks.

### TECHNICAL FIELD

The present disclosure relates generally to communication systems, and more particularly, to user equipment access to, and mobility between, non-public networks.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In one or more aspects of the disclosure, a method, a computer-readable medium, and an apparatus are provided, where the apparatus can be a next generation radio access network (NG-RAN) node. The method may be performed by the NG-RAN node and may comprise receiving, from an access and mobility management function (AMF) of a core network or a second NG-RAN node, a mobility restriction list including a list of equivalent standalone non-public networks (SNPNs). Further, the method may comprise determining a mobility action for a user equipment (UE) connected to the first NG-RAN node based on the mobility restriction list.

In one or more aspects of the disclosure, a method, a computer-readable medium, and an apparatus are provided, where the apparatus can be a non-3GPP access network node. The method may be performed by the non-3GPP access network node and may comprise receiving, from a UE connected to the non-3GPP access network node, a registration request for registering the UE with a core network. The method may further comprise selecting a SNPN identified at least in part by a network identifier (NID). In addition, the method may comprise transmitting, to an AMF of the core network, an initial UE message indicating the selected NID.

In one or more aspects of the disclosure, a method, a computer-readable medium, and an apparatus are provided, where the apparatus can be a NG-RAN node of a public network integrated non-public network (PNI-NPN). The method may be performed by the NG-RAN node and may comprise receiving, from an AMF of a core network, an allowed PNI-NPN list including location validity information and/or time validity information for a UE to access a localized service via the PNI-NPN. The method further comprises providing the UE access to the localized service based on the location validity information and/or the time validity information in the allowed PNI-NPN list.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network in accordance with one or more aspects of the present disclosure.

FIG. 2 is a diagram illustrating an example of a wireless communications system and an access network in accordance with one or more aspects of the present disclosure.

FIG. 3 is a diagram illustrating an example of a wireless communication system that supports mechanisms for establishing user plane connectivity for non-3GPP access in accordance with one or more aspects of the present disclosure.

FIG. 4 is a diagram illustrating an example of a wireless communication system that supports mechanisms for establishing user plane connectivity for non-3GPP access in accordance with one or more aspects of the present disclosure.

FIG. 5 is a diagram illustrating an example of a next generation-radio access network (NG-RAN) node or base station and user equipment (UE) in an access network in accordance with one or more aspects of the present disclosure.

FIG. 6 is a signaling diagram illustrating an example communication between a first NG-RAN, and multiple NG-RANs and an access and mobility management function (AMF) of a core network (CN) in accordance with one or more aspects of the present disclosure.

FIG. 7 is a signaling diagram illustrating an example communication between a non-3GPP access network node, a UE, and an AMF in accordance with one or more aspects of the present disclosure.

FIG. 8 is a signaling diagram illustrating an example communication between an AMF of a CN and a NG-RAN node in accordance with one or more aspects of the present disclosure.

FIG. 9 is a flowchart of a method of wireless communication in accordance with one or more aspects of the present disclosure.

FIG. 10 is a flowchart of a method of wireless communication in accordance with one or more aspects of the present disclosure.

FIG. 11 is a flowchart of a method of wireless communication in accordance with one or more aspects of the present disclosure.

FIG. 12 is a diagram illustrating an example of a hardware implementation for an example UE in accordance with one or more aspects of the present disclosure.

FIG. 13 is a diagram illustrating an example of a hardware implementation for an example NG-RAN node in accordance with one or more aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, implementations and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, aggregated or disaggregated components, end-user devices, etc. of varying sizes, shapes, and constitution.

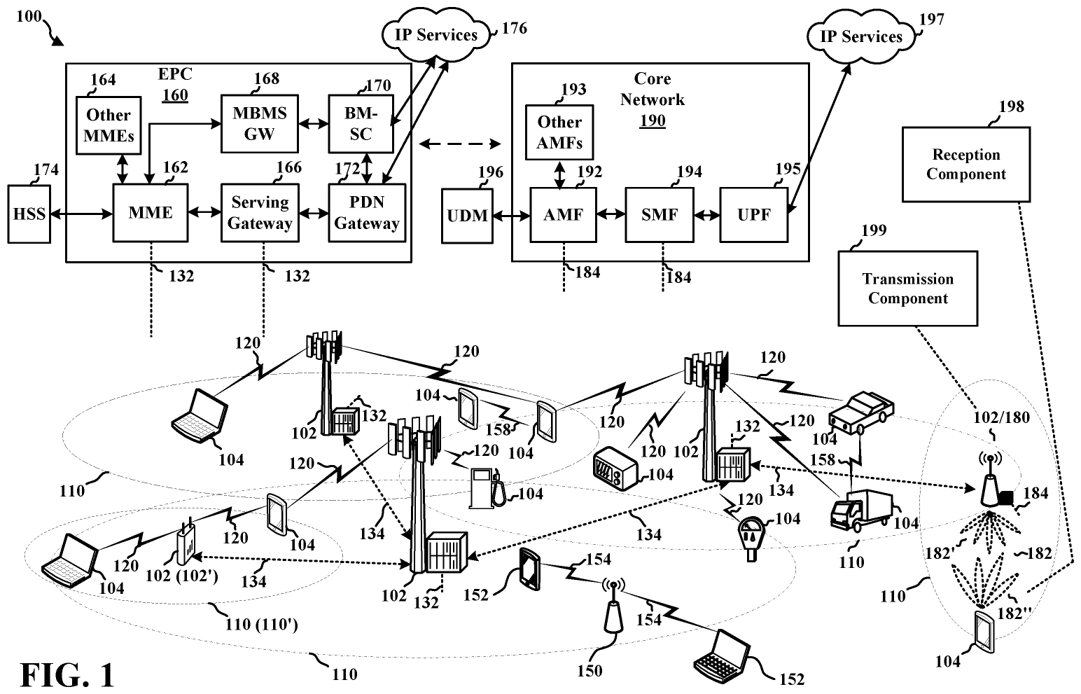

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHZ (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

A UE 104 may belong to a public land mobile network (PLMN), which may be a home public land mobile network (HPLMN) or a visited public land mobile network (VPLMN). A PLMN may be a geographic region (e.g., a country) covered by a mobile operator to provide various wireless communication services (e.g., voice and data services) to the UE 104. In some examples, each public network may be identified by a mobile country code (MCC). Using various identifiers of the UE 104, an HPLMN can be identified. In some cases, the UE 104 may roam to different geographic regions (e.g., different countries). The UE 104 may attach to a roaming network, which may be referred to as a visiting network. In one example, while connected to a visiting network, the UE may register with and connect to a standalone non-public network (SNPN) to access SNPN services. For example, a UE 104 connected to a visiting network may want to register with a network of a specific company, which is a non-public network. A UE 104 that is configured to or capable of connecting to a SNPN may be referred to as a SNPN enabled UE.

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHZ, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHZ). Although a portion of FR 1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHZ), FR4 (52.6 GHz-114.25 GHZ), and FR5 (114.25 GHZ-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHZ spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Although the following description may be focused on 5G NR, the concepts described herein may be applicable to other similar areas, such as LTE, LTE-A, CDMA, GSM, and other wireless technologies.

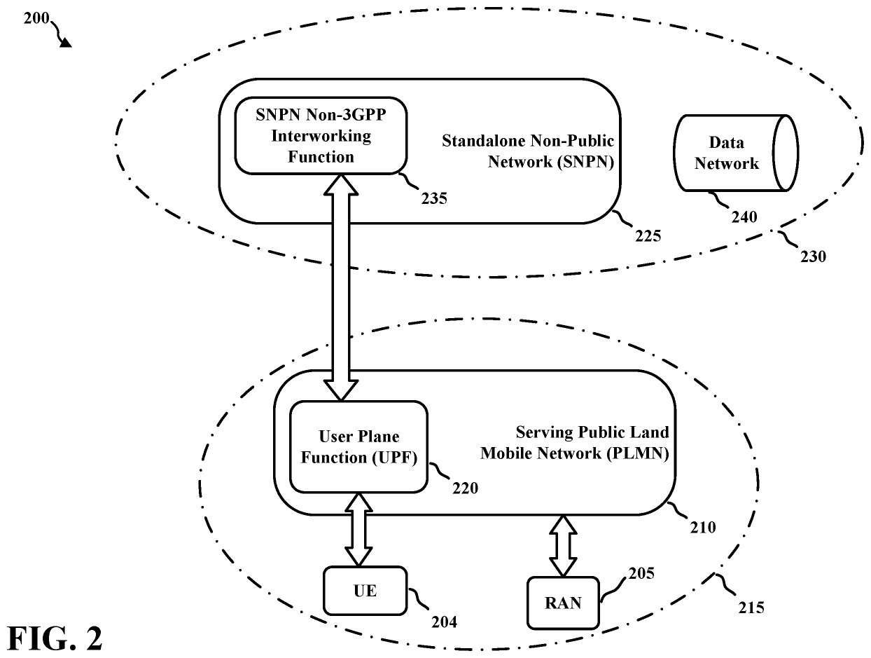

FIG. 2 illustrates an example of a wireless communications system 200 in accordance with one or more aspects of the present disclosure. The wireless communications system 200 may support multiple radio access technologies including 4G systems such as LTE systems, LTE-A systems, or LTE-A Pro systems, and 5G systems, which may be referred to as new radio (NR) systems. The wireless communications system 200 may implement aspects of the wireless communications system 100. For example, the wireless communications system 200 may include a UE 204, which may be examples of a UE 104 as described with reference to FIG. 1. The UE 204 may be a SNPN enabled UE. The wireless communications system 200 may also include a radio access network (RAN) 205, a serving PLMN 210 associated with a geographic location 215, a user plane function (UPF) 220 (e.g., which may be an example of UPF 195), a SNPN 225 associated with a geographic location 230, a SNPN access network node (e.g., a non-3GPP interworking function (N3IWF)) 235, and a data network 240.

The wireless communications system 200 may, in some examples, be a non-public network (NPN), which may be a 5G system (5GS) deployed for non-public wireless communications. The NPN may be, for example, the SNPN 225, which may be operated by an NPN operator and might not rely on network functions by a PLMN. A network function may be a logical node within a network infrastructure (e.g., such as the wireless communications system 200) with various functions relating to, for example, subscriber sessions (e.g. session establishment, modify and release), security and access management and authorization, and the like. A non-public network function may be a logical node not provided by a PLMN and that is deployed for non-public use in a non-public network. A public network function may be a logical node provided by a PLMN and that is deployed for public use in a public network. Alternatively, the NPN may be a public network integrated NPN (PNI-NPN), which may be an NPN deployed with support of a PLMN. A SNPN and a PLMN may share a RAN, such as the RAN 205. The UE 204 may use a PLMN identifier (ID) or a network identifier (NID), or both, to identify a SNPN, for example the SNPN 225. In some examples, an PLMN ID might not be unique for a SNPN.

In the case of PNI-NPN, PLMN ID and/or a closed access group (CAG) ID may be used to identify PNI-NPNs. For example, PLMN ID identifies the network, and the CAG ID identifies the CAG cells. A CAG identifies a group of subscribers who are permitted to access one or more CAG cells associated to the CAG. CAG is used for the PNI-NPNs to prevent UE(s), which are not allowed to access the NPN via the associated cell(s), from automatically selecting and accessing the associated CAG cell(s). A CAG cell broadcasts one or multiple CAG Identifiers per PLMN. Network selection and reselection are based on PLMN ID. Cell selection and reselection, and access control can be based on CAG ID. In one or more aspects, the CAG cell can broadcast information such that only UEs supporting CAG can access the cell.

The RAN 205 (e.g., a next generation RAN (NG-RAN)) may provide access to a SNPN, such as the SNPN 225, by broadcasting various system information to the UE 204. In some examples, the RAN 205 may broadcast one or multiple PLMN IDs. In some other examples, the RAN 205 may broadcast a list of network identifications (NIDs) per PLMN ID identifying NPNs that the RAN 205 provides access to. In other examples, the RAN 205 may broadcast a hostname (e.g., a human-readable network name) per NID. The UE 204 may also provide information, such as resource requirements for a service, a priority of the service, among other information to the RAN 205, which the RAN 205 may use to select a data network, such as the data network 240 to provide the service.

A SNPN-enabled UE, such as the UE 204, may be configured with a subscriber permanent identifier (SUPI) and credentials for each subscribed SNPN identified by the PLMN ID or the NID, or both. The UE 204 may identify a subscriber of a SNPN, such as the SNPN 225, based at least in part on a SUPI including a network-specific identifier that corresponds to a network access identifier (NAI) using an NAI RFC-based user identification technique (e.g., an NAI RFC 7542). A domain part of the NAI may include an NID of the SNPN. Alternatively, the UE 204 may identify the subscriber of the SNPN based at least in part on a SUPI including an international mobile subscriber identity (IMSI). An IMSI may be a unique identifier allocated to the UE 204 and may include an MCC, a mobile network code (MNC), and a mobile subscriber identification number (MSIN). A SNPN-enabled UE, such as the UE 204, may thereby support a SNPN access mode. When the UE 204 is configured to operate in the SNPN access mode, the UE 204 may exclusively select and register with SNPNs, for example, the SNPN 225 over a universal mobile telecommunications system (UMTS) air interface (e.g., Uu interface).

The UE 204 may identify available PLMN IDs and list of available NIDs from the broadcasted system information and select a PLMN based at least in part on the identified available PLMN IDs and list of available NIDs from the broadcasted system information. In some examples, for automatic network selection, the UE 204 may select and attempt to register with an available SNPN, such as the SNPN 225, identified by a PLMN ID and NID for which the UE 204 has a SUPI and credentials. If multiple SNPNs are available that the UE 204 has respective SUPI and credentials for, then the UE 204 may select a SNPN based at least in part on UE capability or UE configuration. Alternatively, for manual network selection, the UE 204 may provide a list of SNPNs, where each SNPN is identified by a PLMN ID and NID, as well as a hostname (e.g., a related human-readable names, if available) of the available SNPNs the UE 204 has respective SUPI and credentials for.

When the UE 204 performs a registration procedure, for example, an initial registration to a SNPN, such as the SNPN 225, the UE 204 may indicate the selected NID and the corresponding PLMN ID to the RAN 205 (e.g., NG-RAN). The RAN 205 may inform an access management function (AMF) of the selected PLMN ID and NID.

To access PLMN services, the UE 204 may perform another registration via a SNPN user plane with a PLMN using the credentials of that PLMN with the SNPN (e.g., the SNPN 225) taking the role of an untrusted non-3GPP access. The UE 204 may perform the other registration, for example, when operating in a SNPN access mode and based at least in part on the UE 204 successfully registering with the SNPN (e.g., the SNPN 225). Alternatively, to access SNPN services, the UE 204, based at least in part on successfully registering with a PLMN over 3GPP access, may perform another registration via the PLMN user plane with a SNPN using the credentials of the SNPN with the PLMN taking the role of untrusted non-3GPP access of the SNPN (i.e. using procedures for untrusted non-3GPP access). The UPF 220 may include user plane function functionality. For example, the UPF 220 may additionally or alternatively support packet routing and forwarding, packet inspection, a quality-of-service (QOS) flow handling, acts as external protocol data unit session point of interconnect to the data network 240, and functions as an anchor point for intra-radio access technology mobility and inter-radio access technology mobility.

The serving PLMN 210 may, in some examples, be a HPLMN or a VPLMN for the UE 204. The UE 204 may be configured to select an N3IWF. An HPLMN may configure the UE 204 with various information. In some examples, the HPLMN may configure the UE 204 with a packet gateway identifier configuration. In some cases, the packet gateway may be an example of an evolved packet data gateway (ePDG), and the packet gateway identifier configuration may be an example of an ePDG identifier configuration. In some case, the packet gateway may be an example of an N3IWF, and the packet gateway identifier configuration may be an example of an N3IWF identifier configuration. The packet gateway identifier configuration may include a fully-qualified domain name (FQDN). The FQDN may define a location of a network node within a domain name system (DNS). FQDNs may also allow the DNS to trace an address of a network node, such as a server, through a DNS tree hierarchy to a top level domain and eventually to a root name server. In some other examples, the packet gateway identifier configuration may include an IP address of an packet gateway in the HPLMN. The HPLMN may configure the UE 204 with the packet gateway identifier configuration based at least in part on the UE 204 supporting connectivity with a packet gateway and attempting to select a packet gateway in the wireless communications system 200.

The HPLMN may configure the UE 204 with an N3IWF identifier configuration. The N3IWF identifier configuration may include an FQDN or an IP address of an N3IWF in the HPLMN. In other examples, the HPLMN may configure the UE 204 with non-3GPP access node selection information, which may include a list of PLMNs. In some examples, each PLMN in the list of PLMNs may be associated with a priority. Each PLMN may also be associated with one or more fields defining a parameter. For example, each PLMN may be configured with a preference field, which may identify if a packet gateway or an N3IWF is preferred for a corresponding PLMN. Additionally or alternatively, each PLMN may be configured with an FQDN field that identifies if the UE 204 uses a tracking and location area identity FQDN or an operator identifier FQDN, for discovering an address of a packet gateway or an N3IWF in a corresponding PLMN. In some examples, the list of PLMNs may include a HPLMN field and a PLMN entry field, which matches a PLMN the UE 204 is connected to except the HPLMN. The packet gateway identifier configuration and the N3IWF identifier configuration may be optional parameters for the UE 204. The non-3GPP access node selection information might not be optional and may include at least the HPLMN field and the PLMN entry field.

The UE 204 may determine to select a packet gateway in the HPLMN based at least in part on that the UE 204 is configured with the packet gateway identifier configuration. The UE 204 may use the packet gateway identifier configuration to identify an IP address of the packet gateway in the HPLMN, and may ignore an FQDN field of the HPLMN in the non-3GPP access node selection information. In some examples, the UE 204 may determine to select an N3IWF in the HPLMN based at least in part on that the UE 204 is configured with the N3IWF identifier configuration. The UE 204 may use the N3IWF identifier configuration to identify an IP address of an N3IWF in the HPLMN, and may ignore an FQDN field of the HPLMN in the non-3GPP access node selection information.

The UE 204 may be configured to select an N3IWF, such as the SNPN N3IWF 235. In some examples, the UE 204 may be configured to select an N3IWF based on selecting a packet gateway. As part of selecting an N3IWF, the UE 204 may determine a tracking and location area identifier FQDN based at least in part on a tracking area where the UE 204 is located. The tracking and location area identifier FQDN may use a 5G system (5GS) tracking area identity (TAI) when the UE 204 is registered to the 5GS, or an evolved packet system (EPS) TAI when the UE 204 is registered to an EPS. In some examples, a packet gateway operator identifier (OI) FQDN format may be substituted with an N3IWF OI FQDN format. The packet gateway identifier configuration and the packet gateway selection information may also be substituted by the N3IWF identifier configuration and the non-3GPP access node selection information. The UE 204 may assign a preference to the N3IWF in all PLMNs in the non-3GPP access node selection information independent of the preference parameter. In some examples, network slice information might not be used for the N3IWF selection. Therefore, the UE 204 may access a SNPN service via a PLMN by using a configured N3IWF FQDN to select an N3IWF deployed in the NPN.

An N3IWF FQDN may be provisioned by a home operator or constructed by the UE 204 in either the OI FQDN format or the TAI FQDN format. The N3IWF FQDN may be used as input to a DNS for N3IWF selection. In some examples, for the UE 204 to access PLMN services via a SNPN, the UE 204 operating in SNPN access mode registered to a SNPN (e.g., the SNPN 225) may use the N3IWF selection procedure. The UE 204 may, in some examples, use TAIs from a PLMN to construct a TAI-based N3IWF FQDN. The UE 204 may, in some examples, ignore an N3IWF FQDN for N3IWF selection configured by a SNPN (e.g., the SNPN 225). In order to access SNPN services via a PLMN, a SNPN-enabled UE registered to a PLMN may use a configured N3IWF FQDN to select an N3IWF in a SNPN (e.g., the SNPN 225).

Accordingly, the UE 204 may access SNPN services using untrusted non-3GPP mechanisms by using the SNPN N3IWF 235 in the SNPN 225, and treating a registered PLMN as an untrusted access. In some examples, the UE 204 may have a subscription with an NPN in a home geographic location (e.g., a home country). In some other examples, the UE 204 may have a subscription with an HPLMN and may be roaming and be served by a VPLMN. In other examples, the UE 204 may use a subscription with a serving PLMN in a serving geographic location (e.g., a serving country), and therefore is not roaming, but the serving geographic location may be different from the home geographic location (e.g., home country) where the NPN is located. In some examples, there might not be an agreement between the NPN and various VPLMNs.

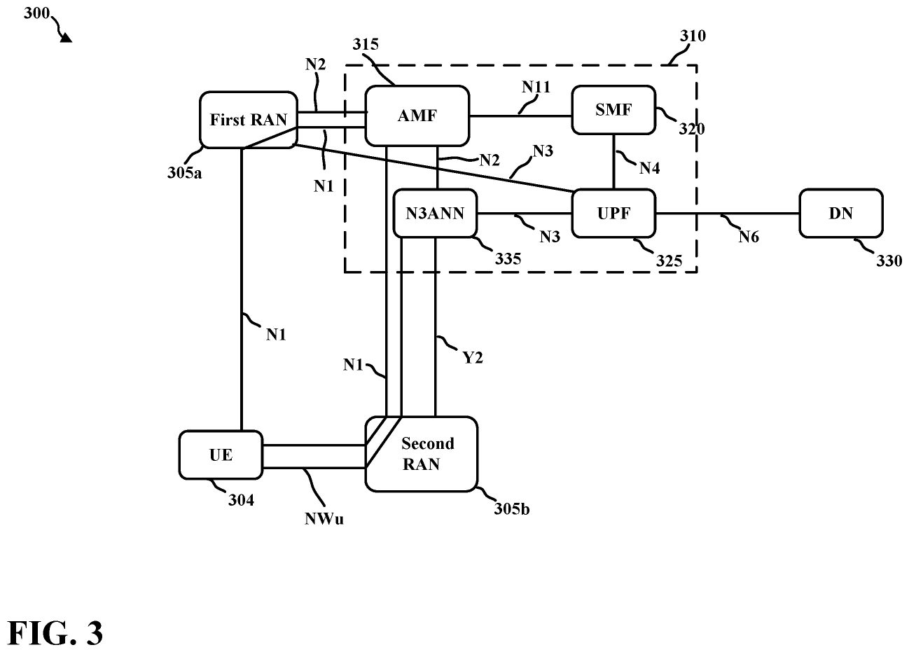

FIG. 3 shows an example of a wireless communications system 300 in accordance with one or more aspects of the present disclosure. Wireless communications system 300 may include UE 304 and core network 310, which may be examples of a UE 104 and a core network 190, respectively, and may communicate with one another as described above with reference to FIG. 1. Core network 310 may include AMF 315, SMF 320, UPF 325, and non-3GPP access network node (N3ANN) 335 (e.g., an untrusted N3IWF, a trusted non-3GPP gateway function (TNGF), etc.), among other components. Wireless communications system 300 may also include first RAN 305a, second RAN 305b and data network (DN) 330.

In some aspects, UE 304 may communicate with core network 310 via first RAN 305a using a first RAT and/or second RAN 305b using a second RAT. First RAN 305a may be a 3GPP RAN in which communications are transmitted over a 3GPP access, while second RAN 305b may be a non-3GPP RAN in which communications are transmitted over a non-3GPP access. In other examples, both first RAN 305a and second RAN 305b may be 3GPP RANs in which communications are transmitted over a 3GPP access. First RAN 305a may also be referred to as a first access, and second RAN 305b may also be referred to as a second access.

As discussed above, core network 310 may be used to provide UE 304 with access to a wireless communication network and to transport data from DN 330 to UE 304. For instance, core network 310 may restrict or authorize UE 304 to access the network and may support mobility services for UE 304 as UE 304 moves about the network coverage area. Core network 310 may include one or more AMFs, SMFs, UPFs, and an N3IWF, which may each perform functions to support establishing a wireless connection between UE 304 and core network 310.

AMF 315 may provide access and mobility management services for UE 304. In some examples, AMF 315 may serve as the primary point of control plane signaling communications with UE 304, such that all control plane communications between UE 315 and the core network 310 may pass through AMF 315 (either directly for communications over 3GPP access, or both directly and indirectly via the N3ANN 335 for non-3GPP access). In some examples, an N1 signaling interface is used solely for control plane signaling (i.e., is used to signal information for control plane services but not to transport user plane data). For example, for uplink communications, UE 304 may identify a payload for a control plane service to transmit to a specific network entity (or function) of the core network 310, and may transmit the payload to AMF 315. Similarly, for downlink communication, a network entity (or function) may transmit a payload for a control plane service to AMF 315, and AMF 315 may relay the payload to UE 304 over control plane signaling over N1. AMF 315 may communicate with SMF 320 over interface N11, and may communicate with UE 115-a over interface N1. Communications between AMF 315 and UE 304 may be over 3GPP access or non-3GPP access. In some examples, AMF 315 may page UE 304. For instance, AMF 315 may page UE 304 if UE 304 is in a connection management (CM) idle (CM_IDLE) state. In some aspects, AMF 315 may transmit the paging message to UE 304 over the 3GPP access, while in other aspects, AMF 315 may transmit the paging message to UE 304 over the non-3GPP access.

SMF 320 may provide session management services for the UE 304. Specifically, SMF 320 may establish, modify, and release sessions (or bearers) for communication between UE 304 and DN 330. For example, SMF 320 may maintain a tunnel for communication between UPF 325 and an access network (AN) node. In addition, SMF 320 may allocate and manage IP addresses or Ethernet addresses for UE 304, select and control user plane functions, configure traffic steering at UPF 325 to route traffic to proper destinations, terminate session management (SM) parts of non-access stratum (NAS) messages, and provide roaming functionality. SMF 320 may communicate with UPF 325 over communications link N4 and may communicate with AMF 315 over communications link N11. For example, SMF 320 may receive a notification from UPF 325 over communications link N4 when there is no user plane tunnel N3 established for an existing session. The notification may indicate that there is data (e.g., one or more PDUs) ready for transmission to UE 304 for a PDU session. In some aspects, a PDU session must be established before UE 304 may exchange user data with core network 310.

In some examples, SMF 320 may relay this information to AMF 315 over communications link N11. In other examples, SMF 320 may determine whether to transmit a paging request to AMF 315 over communications link N11 based at least in part on information stored at SMF 320. For example, SMF 320 may store data related to a paging state of SMF 320. The paging state may be a no paging state or a paging state. The paging state of SMF 320 may be indicated by a timer such that SMF 320 is in the no paging state while the timer is active and in the paging state when the timer is inactive. SMF 320 may also store data related to a CM state of the UE 304. The CM state of UE 304 may be an idle state (e.g., CM_IDLE), an active state (e.g., CM_CONNECTED), or an unknown state.

UPF 325 may include functionality for serving as the point of interconnect to DN 330 for an external PDU session. In some aspects, UPF 325 may be the anchor point for intra-RAT and inter-RAT mobility. UPF 325 may route and forward packets to and from DN 330, inspect packets and enforce policy rules in the user plane, report traffic usage, handle quality of service (QOS) for user plane packets, and verify uplink traffic.

N3ANN 335 may include functionality for serving as an intermediary between UE 304 and AMF 315 for communications over the non-3GPP access, especially for registration and session establishment. For example, during registration N3ANN 335 may select an appropriate AMF and relay authentication and registration messages received from UE 304 to AMF 315, and vice versa. N3ANN 335 may also route uplink and downlink transmissions between UE 304 and DN 330 via UPF 325 over communications link N3. In one or more aspects, N3ANN 335 can be or include a N3IWF. In one or more aspects, N3ANN 335 can be or include a TNGF.

DN 330 may be used to transfer data between network access point. In some aspects, DN 330 may be an example of a local DN, a central DN, or a public land mobile network (PLMN). In some wireless systems (e.g., a 5G wireless system), UE 304 may access DN 330 to exchange data packets, or one or more PDUs, using a PDU session. A PDU session may be an association between UE 304 and DN 330 that provides a PDU connectivity service. The association between UE 304 and DN 330 in a PDU session may use IP or Ethernet, or the association may be unstructured.

UE 304 may perform a registration procedure to register with core network 310 to receive authorization to access mobile services (e.g., an initial registration), enable mobility tracking, and/or enable reachability. UE 304 may perform a registration procedure for initial access to core network 310, when changing to a new tracking area (TA) while in an idle mode, and/or when performing a periodic update.

In some examples, UE 304 may register over one or more accesses to core network 310. For instance, UE 304 may register to core network 310 via first RAN 305a. First RAN 305a may be a 3GPP access network (e.g., LTE, 5G, etc.), and may be referred to as a 3GPP access. UE 304 may also register to the same or a different core network 310 via second RAN 305b. Second RAN 305b may be a non-3GPP access or an untrusted non-3GPP access (e.g., Wi-Fi), and may be referred to as a non-3GPP access. When the UE 304 registers over first RAN 305a and second RAN 305b to the same core network (e.g., core network 310), AMF 315 may be used to manage and keep track of both the 3GPP access and the non-3GPP access. When the UE registers over first RAN 305a and second RAN 305b to different core networks (e.g. different PLMNs), multiple AMFs may be used, where one AMF may manage and keep track of the 3GPP access and the other AMF may manage and keep track of the non-3GPP access. In some aspects, UE 304 may access core network 3101 via first RAN 305a while concurrently accessing core network 310 via second RAN 305b. In other aspects, UE 304 may access core network 310 solely via first RAN 305a or second RAN 305b.

UE 304 may also be associated with a resource management (RM) state. For instance, UE 304 may either be in RM_DEREGISTERED state or RM_REGISTERED state. The RM state of UE 304 may depend on a type of registration procedure being performed by UE 304. For instance, if UE 304 is performing a registration procedure for an initial access to core network 310, UE 304 may be in RM_DEREGISTERED state. And if UE 304 is performing a registration procedure after entering a new TA, then UE 304 may be in RM_REGISTERED state.

UE 304 may also be associated with a CM state. For instance, UE 304 may either be in CM_CONNECTED state or a CM_IDLE state. When UE 304 has no NAS signaling connection established with AMF 315 over the N1 link, UE 304 may be in the CM_IDLE state. When UE 304 has a NAS signaling connection established with AMF 315 over the N1 link, UE 304 may be in the CM_CONNECTED state. While in CM_IDLE state, UE 304 may respond to paging from AMF 315 or perform a service request when UE 304 has uplink signaling or user data to send to core network 310. UE 304 may transition to CM_CONNECTED state when a signaling connection is established with core network 310 (e.g., when UE 304 enters an RRC Connected state over a 3GPP access (e.g., via first RAN 305a) or establishes a PDU Session). UE 304 may also enter CM_CONNECTED state when an initial NAS message, such as a registration request, service request, or deregistration request, is sent. UE 304 may transition to the CM_IDLE state when an established signaling connection with core network 310 is released. AMF 315 may similarly transition between CM_CONNECTED state and CM_IDLE state. In some aspects, AMF 315 may release a NAS signaling connection with UE 304, and both UE 304 and AMF 315 may transition to CM_IDLE state. In some cases, AMF 315 stores an RM state and a CM state for UE 304 for each access.

In some examples, UE 304 registers with core network 310 without establishing a PDU session. When UE 304 is registered with core network 310 without an established PDU session and is in CM_CONNECTED state, UE 304 may maintain a signaling link with AMF 315 and maintain the ability to exchange NAS signaling via an N1 signaling interface. Thus, control plane services that use the control plane as transport (e.g., non-PDU services) are available to UE 304. For instance, UE 304 may have an N1 signaling interface established between AMF 315 and first RAN 305a. UE 304 may also have a N1 signaling interface established between AMF 315 and second RAN 305b via N3ANN 335 (e.g., N3IWF). When first RAN 305a is a 3GPP access and UE 304 has a NAS signaling connection established with AMF 315 over first RAN 305a, UE 304 may be in a 3GPP RM_REGISTERED state and CM_CONNECTED state.

As discussed above, UE 304 may register with core network 310 via first RAN 305a and/or second RAN 305b. In some examples, certain accesses may have different conditions for communicating with core network 310 than other accesses. For instance, core network 310 may be able to page UE 304a over first RAN 305a, but not over second RAN 305b (e.g., for accesses that establish connectivity via an IP secure tunnel). In some aspects, each access may be associated with its own RM state and CM state and communications over the one or more accesses may be based on a state combination of the one or more accesses.

In some aspects, UE 304 may communicate signaling for one or more control plane services over the one or more accesses based on the state combination of each of the one or more accesses. For instance, if UE 304 is in CM_CONNECTED state over first RAN 305a and is in CM_IDLE state over second RAN 305b and cannot be paged over second RAN 305b, UE 304 may communicate both mobile-originated (MO) signaling—i.e., signaling generated at the UE and sent to a base station—and mobile terminated (MT) signaling—i.e., signaling generated at the base station and sent to the UE—for a control plane service over first RAN 305a at least until UE 304 transitions to CM_CONNECTED state over second RAN 305b. In another instance, if UE 304 is in CM_IDLE state over first RAN 305a and can be paged over first RAN 305a, and is in CM_CONNECTED state over second RAN 305b, UE 304 may perform both MO and MT transmissions for a control plane service over either first RAN 305a or second RAN 305b. In another instance, if UE 304 is in CM_IDLE state over first RAN 305a and cannot be paged over first RAN 305a (e.g., is outside of the coverage area), and is in CM_CONNECTED state over second RAN 305b, UE 304 may perform both MO and MT transmissions for a control plane service over second RAN 305b. And in another instance, if UE 304 is in CM_IDLE state over first RAN 305a and cannot be paged over first RAN 305a, and is in CM_IDLE state over second RAN 305b and cannot be paged, UE 304 may perform MO transmissions for a control plane service over second RAN 305b after UE 304 transitions to CM_CONNECTED state over second RAN 305b.

In some aspects, core network 310 and/or UE 304 may have a preference for delivering MO or MT signaling for a control plane service over a certain access (e.g., delivery preferences). In some aspects, the delivery preferences of core network 310 and/or UE 304 may be dependent on a registration and connection management state of UE 304 over first RAN 305a and second RAN 305b (e.g., based on the instances set forth above). In some aspects, core network 310 and/or UE 304 may also have policies restricting the delivery of MO and/or MT signaling on certain access for certain control plane services. For instance, core network 310 may prohibit signaling of control plane services that use 3GPP location services over an access using a non-3GPP access (e.g., second RAN 305b).

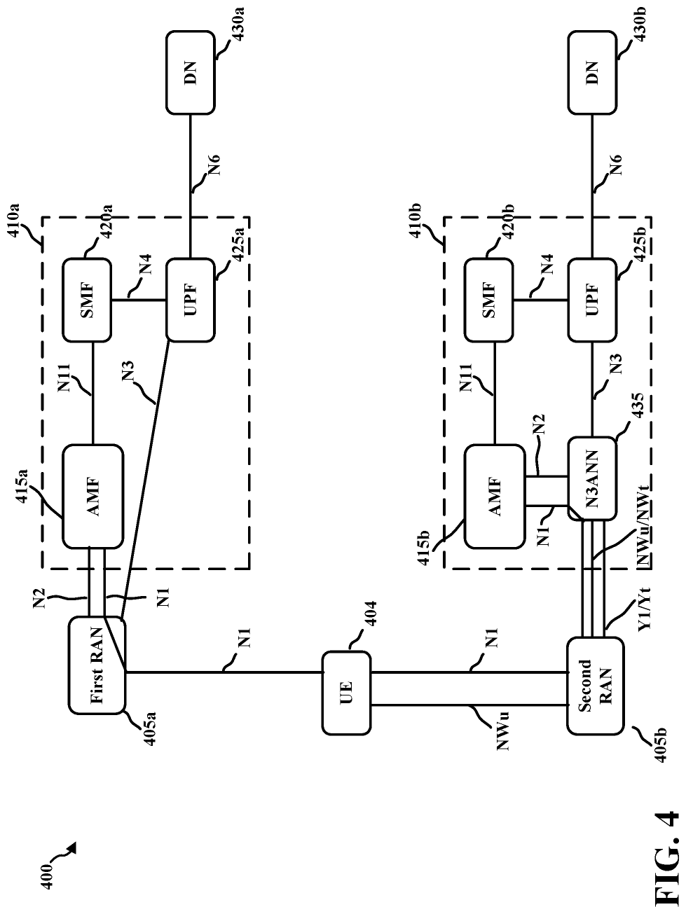

FIG. 4 shows an example of a wireless communications system 400 in accordance with one or more aspects of the present disclosure. Wireless communications system 400 may include UE 404, first core network 410a, and second core network 410b, which may be examples of a UE 304 and a core network 310, respectively, and may communicate with one another as described above with reference to FIG. 3. Wireless communications system 400 may also include first RAN 405a, second RAN 405b, AMFs 415, SMFs 420, UPFs 425, N3ANN 435, first DN 430a and second DN 430b, among other components. For example, first core network 410a includes first AMF 415a, first SMF 420a, and first UPF 425a, while second core network 410b includes second AMF 415b, second SMF 420b, second UPF 425b, and N3ANN 435. First RAN 405a and second RAN 405b may be examples of first RAN 305a and second RAN 305b, respectively; first AMF 415a and second AMF 415b may be examples of AMF 315; first SMF 420a and second SMF 420b may be examples of SMF 320; first UPF 425a and second UPF 425b may be examples of UPF 325; N3ANN 435 may be an example of N3ANN 335; and first DN 430a and second DN 430b may be examples of DN 330.

In some examples, UE 404 may register to first core network 410a over first RAN 405a and may register to second core network 410b over second RAN 405b. In some examples, UE 404 may use first AMF 415a to manage the delivery of control plane services over first RAN 405a and second AMF 415b to manage the delivery of control plane services over second RAN 405b. In some aspects, first AMF 415a stores an RM and CM state for UE 404 over first RAN 405a, while second AMF 415b stores an RM and CM state for UE 404 over second RAN 405b. In some examples, UE 404 communicates first access preferences for communicating signaling for one or more control plane services over first AMF 415a and second access preferences for communicating signaling for one or more control plane services over second AMF 415b. In some aspects, UE 404 may communicate with first AMF 415a based on a registration and connection management state of UE 404 for first RAN 405a, and may communicate with second AMF 415b based on a registration and connection management state of UE 404 for second RAN 405b. In some examples, second AMF 415b may restrict certain control plane services from using an N1 signaling interface for second RAN 405b.

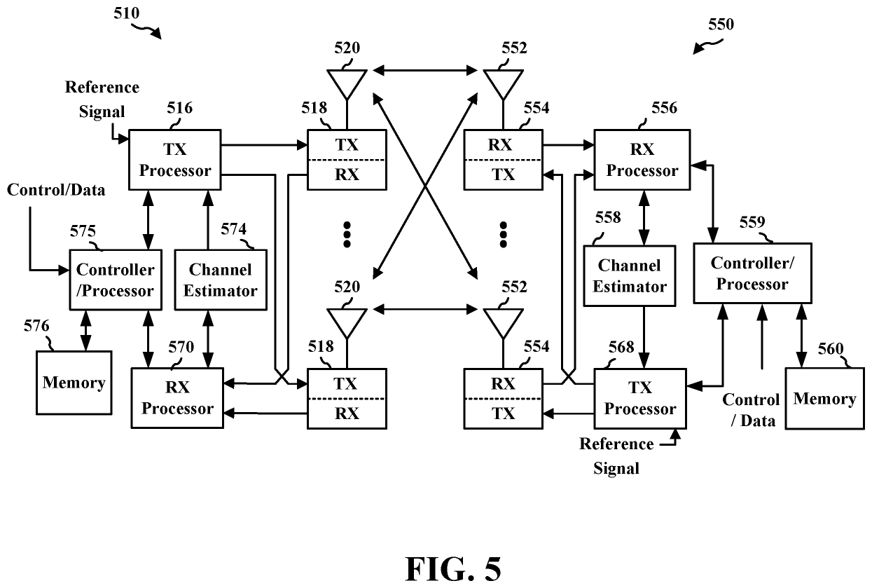

FIG. 5 is a block diagram of a base station/NG-RAN 510 in communication with a UE 550 in an access network. In the DL, IP packets from the EPC 160 may be provided to a controller/processor 575. The controller/processor 575 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 575 provides RRC layer functionality associated with broadcasting of system information (e.g., Master Information Block (MIB), System Information Blocks (SIBs)), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through hybrid automatic repeat request (HARQ), priority handling, and logical channel prioritization.

The transmit (TX) processor 516 and the receive (RX) processor 570 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 516 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 574 may be used to determine the coding and modulation scheme, as well as for spatial processing. The channel estimate may be derived from a reference signal and/or channel condition feedback transmitted by the UE 550. Each spatial stream may then be provided to a different antenna 520 via a separate transmitter 518 TX. Each transmitter 518 TX may modulate a radio frequency (RF) carrier with a respective spatial stream for transmission.

At the UE 550, each receiver 554 RX receives a signal through its respective antenna 552. Each receiver 554 RX recovers information modulated onto an RF carrier and provides the information to the receive (RX) processor 556. The TX processor 568 and the RX processor 556 implement layer 1 functionality associated with various signal processing functions. The RX processor 556 may perform spatial processing on the information to recover any spatial streams destined for the UE 550. If multiple spatial streams are destined for the UE 550, they may be combined by the RX processor 556 into a single OFDM symbol stream. The RX processor 556 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 510. These soft decisions may be based on channel estimates computed by the channel estimator 558. The soft decisions are then decoded and deinterleaved to recover the data and control signals that were originally transmitted by the base station 510 on the physical channel. The data and control signals are then provided to the controller/processor 559, which implements layer 3 and layer 2 functionality.

The controller/processor 559 can be associated with a memory 560 that stores program codes and data. The memory 560 may be referred to as a computer-readable medium. In the UL, the controller/processor 559 provides demultiplexing between transport and logical channels, packet reassembly, deciphering, header decompression, and control signal processing to recover IP packets from the EPC 160. The controller/processor 559 is also responsible for error detection using an acknowledgment (ACK) and/or negative acknowledgment (NACK) protocol to support HARQ operations.

Similar to the functionality described in connection with the DL transmission by the base station 510, the controller/processor 559 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through automatic repeat request (ARQ), concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 558 from a reference signal or feedback transmitted by the base station 510 may be used by the TX processor 568 to select the appropriate coding and modulation schemes, and to facilitate spatial processing. The spatial streams generated by the TX processor 568 may be provided to different antenna 552 via separate transmitters 554TX. Each transmitter 554TX may modulate an RF carrier with a respective spatial stream for transmission.

The UL transmission is processed at the base station 510 in a manner similar to that described in connection with the receiver function at the UE 550. Each receiver 518RX receives a signal through its respective antenna 520. Each receiver 518RX recovers information modulated onto an RF carrier and provides the information to a RX processor 570.

The controller/processor 575 can be associated with a memory 576 that stores program codes and data. The memory 576 may be referred to as a computer-readable medium. In the UL, the controller/processor 575 provides demultiplexing between transport and logical channels, packet reassembly, deciphering, header decompression, control signal processing to recover IP packets from the UE 550. IP packets from the controller/processor 575 may be provided to the EPC 160. The controller/processor 575 is also responsible for error detection using an ACK and/or NACK protocol to support HARQ operations.

At least one of the TX processor 568, the RX processor 556, and the controller/processor 559 may be configured to perform aspects in connection with reception component 198 of FIG. 1.

At least one of the TX processor 516, the RX processor 570, and the controller/processor 575 may be configured to perform aspects in connection with transmission component 199 of FIG. 1.

UE access to a SNPN, as well as UE mobility between SNPNs, may be facilitated by SNPN operational principles that support idle or connected mode mobility between SNPNs without the need for selection of a new network. For example, one of these principles can be that the NAS protocol for control communication between a UE and an AMF of a core network over an N1 interface (e.g., between UE 304 and AMF 315 in FIG. 3, or between UE 404 and AMF 415 in FIG. 4) may support a list of equivalent SNPNs that are considered to be equivalent to each other by the UE for SNPN selection, cell selection, or cell reselection. For example, when a UE is registered on a SNPN, referred to as a registered SNPN, the list of equivalent SNPNs may include the registered SNPNs and other SNPNs that the UE may consider to be equivalent to the registered SNPN for SNPN selection, cell selection, or cell reselection. A UE may successfully register on a SNPN when the UE has found a suitable cell of the SNPN to camp on and a location registration request of the UE has been accepted in the registration area of the cell on which the UE is camped. As such, the list of equivalent SNPNs includes SNPNs that the UE may consider as equivalent to each other for SNPN selection, cell selection, or cell reselection.

Similarly, the next generation application protocol (NGAP) for control communication between a NG-RAN and a core network over an N2 interface (e.g., between first NG-RAN 305a and AMF 315 of FIG. 3, or between first NG-RAN 405a and AMF 415a of FIG. 4) may also support the list of equivalent SNPNs. In such cases, UE, NG-RAN, and/or AMF may take the list of equivalent SNPNs into consideration for supporting relevant functions such as but not limited to cell selection, cell reselection, handover, idle/connected network selection, etc. In one or more aspects, the UE, NG-RAN, and/or AMF may not provide support for equivalent SNPNs, with different SNPN IDs, within a registration area.

For example, when a UE is switched on, a PLMN or a SNPN may be selected by NAS. For the selected PLMN or SNPN, associated RAT(s) may be set and the NAS may provide a respective list of equivalent PLMNs or list of equivalent SNPNs, if available, that the AS shall use for cell selection and cell reselection. The list of equivalent PLMNs or SNPNs is a list of PLMNs or SNPNs, respectively, that the UE may consider as equivalent for cell selection, cell reselection, and handover according to information provided by the NAS. With cell selection, the UE camps on a cell by searching for a suitable cell of the selected PLMN or selected SNPN, choosing that cell to provide available services, and monitoring its control channel. The UE may, if necessary, register its presence in the tracking area of the chosen cell by means of a NAS registration procedure. As an outcome of a successful location registration, the selected PLMN or SNPN then becomes the registered PLMN or SNPN, respectively.

As discussed above, when a UE has a NAS signaling connection established with an AMF over an N1 link or when an initial NAS message, such as a registration request, is sent to the AMF, the UE may be in the CM_CONNECTED state. When the UE is in CM_CONNECTED state, the UE may be subject to restrictions that apply to subsequent mobility actions by the UE such as but not limited to handover operation, secondary cell group (SCG) selection during dual connectivity procedure, assignment of proper RAN based notification area (RNA), etc. The restrictions can be part of roaming and access restriction information for the UE that are provided by the AMF (e.g., and also updated by the AMF afterwards).

The roaming and access restriction information includes RAT restriction, forbidden area restriction, service area restriction, etc. The RAT restrictions define the 3GPP RATs that a UE is not allowed to access in a PLMN. In a restricted RAT, a UE, based on subscription, is not permitted access to the network for this PLMN. For CM_CONNECTED state, when radio access network determines target RAT and target PLMN during handover operation, it can take per PLMN RAT restriction into consideration. The RAT restriction is enforced in the network, and not provided to the UE. With respect to forbidden area restrictions, the forbidden area is the area where a UE, based on subscription, is not permitted to initiate any communication with the network for this PLMN. The UE behavior in terms of cell selection, RAT selection and PLMN selection depends on the network response that informs the UE of the forbidden area. A forbidden area applies either to 3GPP access or to non-3GPP access. Further, forbidden areas may not be used for untrusted or trusted non-3GPP access.

Service area restrictions define areas in which the UE may or may not initiate communication with the network. Allowed areas are areas where the UE is permitted to initiate communication with the network as allowed by the subscription and non-allowed areas are areas where a UE is service area restricted based on subscription. In non-allowed areas, the UE and the network are not allowed to initiate Service Request, or any connection requests for user plane data, control plane data, exception data reporting, or session management (SM) signaling (except for packet switch (PS) data off status change reporting) to obtain user services that are not related to mobility.

The roaming and access restriction information also includes serving PLMN/SNPN and may include a list of equivalent PLMNs. It may also include PNI-NPN mobility restrictions (e.g., list of CAGs allowed for the UE and whether the UE can also access non-CAG cells). In one or more aspects, the NG-RAN (e.g., gNB) can consider that roaming or access to CAG cells is only allowed if PNI-NPN mobility information is available for the UE. Upon receiving the roaming and access restriction information for a UE, if applicable, the NG-RAN can use it to determine whether to apply restriction handling for subsequent mobility action, e.g., handover, redirection. If the roaming and access restriction information is not available for a UE at the NG-RAN, the NG-RAN can consider that there is no restriction for subsequent mobility actions except for the PNI-NPN mobility.

In one or more aspects, only if received over NG signaling (e.g., from source NG-RAN and AMF) or Xn signaling (e.g., from source NG-RAN to target NG-RAN), the roaming and access restriction information can be propagated over Xn by the source NG-RAN during Xn handover. If the Xn handover results in a change of serving PLMN (e.g., to an equivalent PLMN), the source NG-RAN can replace the serving PLMN with the identity of the target PLMN and move the serving PLMN to the equivalent PLMN list, before propagating the roaming and access restriction information.

In one or more aspects, the roaming and access restriction information can be presented in a mobility restriction list information element (IE) that defines the roaming or access restrictions for subsequent mobility action for which the NG-RAN provides information about the target of the mobility action towards the UE, the subsequent mobility action including the afore-mentioned handover operation, SCG selection during dual connectivity procedure, or assignment of proper RNAs. An example of such an IE is shown in Table 1 below:

TABLE 1
Mobility Restriction List:

| | | | IE type | | | |
|---|---|---|---|---|---|---|
| IE/Group | | | and | | | Assigned |
| Name | Presence | Range | reference | Semantics description | Criticality | Criticality |
| Serving | M | | PLMN | | — | |
| PLMN | | | Identity | | | |
| | | | 9.3.3.5 | | | |
| Equivalent | | 0 . . . <maxnoofEPLMNs> | | Allowed PLMNs in addition to Serving | — | |
| PLMNs | | | | PLMN. This list corresponds to the list | | |
| | | | | of “equivalent PLMNs” as defined | | |
| | | | | in TS 24.501 [26]. This list is part | | |
| | | | | of the roaming restriction information. | | |
| | | | | Roaming restrictions apply to PLMNs | | |
| | | | | other than the Serving PLMN and | | |
| | | | | Equivalent PLMNs. | | |
| >PLMN | M | | 9.3.3.5 | | — | |
| Identity | | | | | | |
| RAT | | 0 . . . <maxnoofEPLMNsPlusOne> | | This IE contains RAT restriction | — | |
| Restrictions | | | | related information as specified in | | |
| | | | | TS 23.501 [9]. | | |
| >PLMN | M | | 9.3.3.5 | | — | |
| Identity | | | | | | |
| >RAT | M | | BIT STRING | Each position in the bitmap represents a | — | |
| Restriction | | | {e-UTRA (0), | RAT. If a bit is set to “1”, the | | |
| Information | | | nR (1), nR- | respective RAT is restricted for the UE. | | |
| | | | unlicensed | If a bit is set to “0”, the respective | | |
| | | | (2)} | RAT is not restricted for the UE. Bits | | |
| | | | (SIZE(8, . . .)) | 3-7 reserved for future use. | | |
| >Extended | O | | 9.3.1.126 | If this IE is included, the RAT | YES | ignore |
| RAT | | | | Restriction Information IE is ignored. | | |
| Restriction | | | | | | |
| Information | | | | | | |
| Forbidden | | 0 . . . <maxnoofEPLMNsPlusOne> | | This IE contains Forbidden Area | — | |
| Area | | | | information as specified in TS | | |
| Information | | | | 23.501 [9]. | | |
| >PLMN | M | | 9.3.3.5 | | — | |
| Identity | | | | | | |
| >Forbidden | | 1 . . . <maxnoofForbTACs> | | | — | |
| TACs | | | | | | |
| >>TAC | M | | 9.3.3.10 | The TAC of the forbidden TAI. | — | |
| Service Area | | 0 . . . <maxnoofEPLMNsPlusOne> | | This IE contains Service Area | — | |
| Information | | | | Restriction information as specified | | |
| | | | | in TS 23.501 [9]. | | |
| >PLMN | M | | 9.3.3.5 | | — | |
| Identity | | | | | | |
| >Allowed | | 0 . . . <maxnoofAllowedAreas> | | | — | |
| TACs | | | | | | |
| >>TAC | M | | 9.3.3.10 | The TAC of the allowed TAI. | — | |
| >Not | | 0 . . . <maxnoofAllowedAreas> | | | — | |
| Allowed | | | | | | |
| TACs | | | | | | |
| >>TAC | M | | 9.3.3.10 | The TAC of the not-allowed TAI. | — | |
| Last E-UTRAN | O | | PLMN | Indicates the E-UTRAN PLMN ID from | YES | ignore |
| PLMN Identity | | | Identity | where the UE formerly handed over to | | |
| | | | 9.3.3.5 | 5GS and which is preferred in case | | |
| | | | | of subsequent mobility to EPS. | | |
| Core Network | O | | ENUMERATED | Indicates whether the UE is restricted | YES | ignore |
| Type | | | (EPCForbidden, | to connect to EPC for the Serving | | |
| Restriction for | | | . . .) | PLMN as specified in TS 23.501 [9]. | | |
| Serving PLMN | | | | | | |
| Core Network | | 0 . . . <maxnoofEPLMNs> | | | YES | ignore |
| Type Restriction | | | | | | |
| for Equivalent | | | | | | |
| PLMNs | | | | | | |
| >PLMN | M | | 9.3.3.5 | Includes any of the Equivalent | — | |
| Identity | | | | PLMNs listed in the Mobility | | |
| | | | | Restriction List IE for which CN | | |
| | | | | Type restriction applies as specified | | |
| | | | | in TS 23.501 [9]. | | |
| >Core Network | M | | ENUMERATED | Indicates whether the UE is restricted | | |
| Type Restriction | | | (EPCForbidden, | to connect to EPC or to 5GC for this | | |
| | | | 5GCForbidden, | PLMN. | | |
| | | | . . .) | | | |
| NPN Mobility | O | | 9.3.1.184 | | YES | reject |
| Information | | | | | | |

One or more aspects of the present disclosure disclose techniques for facilitating a UE's access to SNPNs and/or mobility between SNPNs by enhancing the mobility restriction list to include a list of equivalent SNPNs so that roaming or access restrictions contained within the mobility restriction list may apply for subsequent mobility action by the UE that involves the SNPNs. For example, in one or more aspects, the mobility restriction list IE of Table 1 may be modified to include a list of equivalent SNPNs that the UE may consider to be equivalent for cell selection, cell reselection, handover operations, etc. For instance, Table 1 may be modified to include an “IE/Group Name” item entry of “Equivalent SNPNs” identifying the allowed equivalent SNPNs that can be used for cell selection, cell reselection, handover operations, etc. Further, in some aspects, the mobility restriction list may also include or list the “serving SNPN” (e.g., similar to the “serving PLMN” shown in Table 1). In addition, the SNPN may also be identified under one or more of the restrictions or information elements of the mobility restriction list. For instance, “SNPN identity” may be listed or identified in Table 1 under each one of the information elements including the restrictions, i.e., equivalent SNPNs, RAT restrictions, forbidden area information, service area information, and/or core network type restriction for equivalent SNPNs.

In such aspects, the roaming and access restriction information such as RAT restriction, forbidden area restriction, service area restriction, etc., that apply to the list of equivalent PLMNs may also apply to the list of equivalent SNPNs. For example, the RAT restrictions that define the 3GPP RATs that a UE is not allowed to access in a PLMN may also define the 3GPP RATs that the UE is not allowed to access in a SNPN, and the discussion above related to RAT restrictions and presented with reference to PLMN(s) may equally apply to SNPN(s). As another example, the forbidden area restrictions that identify the forbidden area where a UE is not permitted to initiate any communication with the network for a PLMN may also identify the forbidden area where a UE is not permitted to initiate any communication with the network for a SNPN. Further, the discussion above related to forbidden area restrictions and presented with reference to PLMN(s) may equally apply to SNPN(s). Similarly, service area restrictions discussed above may also apply to SNPN(s).

In one or more aspects, instead of the roaming and access restriction information that applies to PLMN(s) also applying to SNPN(s), a mobility restriction list IE (e.g., similar to the one shown in Table 1) may include roaming and access restriction information that is dedicated to SNPN(s) (e.g., and as such may not apply for PLMNs). For example, the mobility restriction list IE of Table 1 may include “IE/Group Name” item entries “RAT Restrictions”, “Forbidden Area Information/Restrictions”, “Service Area Information/Restrictions”, etc., that are dedicated to SNPNs. In some aspects, these “SNPN-dedicated” restrictions may not apply to PLMNs, but instead may only apply to SNPNs. In some examples, the legacy roaming and access restriction information (e.g., such as that shown in Table 1 above) may apply to PLMNs while the SNPN-dedicated restrictions may apply to SNPNs. In some examples, the mobility restriction list IE of Table 1 may include the SNPN-dedicated restrictions but may exclude roaming and access restriction information directed to or dedicated to PLMNs.

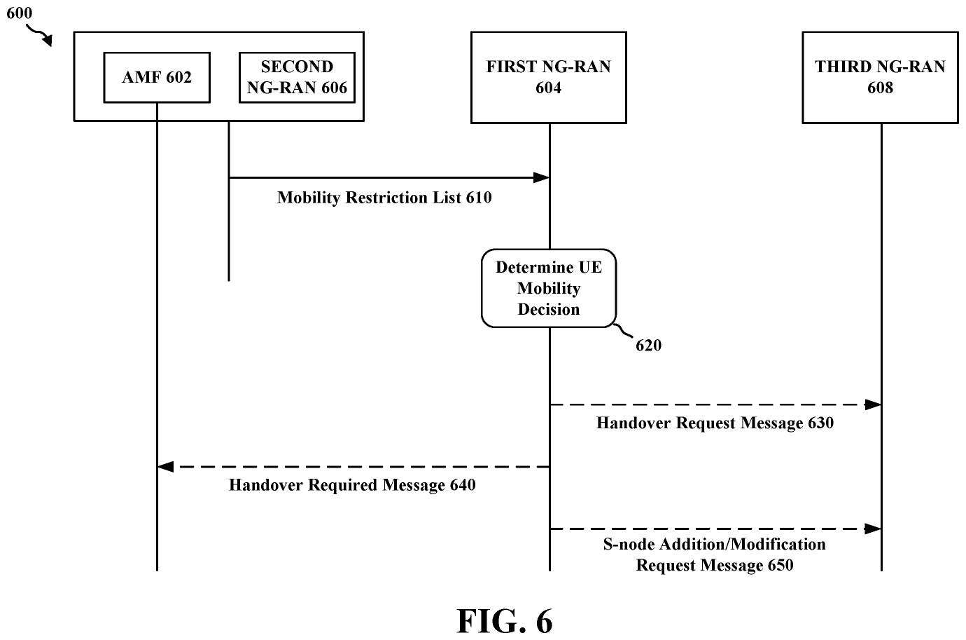

As discussed above, an AMF may provide a NG-RAN the roaming and access restriction information (e.g., the mobility restriction list) via N2 signaling or the NG-RAN may receive the mobility restriction list from another NG-RAN via Xn signaling. FIG. 6 shows a signaling diagram 600 illustrating an example communication between a first NG-RAN 604, and multiple NG-RANs 606, 608 and an AMF 602 of a core network (CN) in accordance with one or more aspects of the present disclosure. In some aspects, the AMF 602 may provide the mobility restriction list 610 to the first NG-RAN 604 via an N2 interface therebetween. In some aspects, the second NG-RAN 606 may propagate the mobility restriction list 610 to the first NG-RAN 604 via an Xn interface therebetween. The mobility restriction list 610 may include the list of equivalent SNPNs and the restrictions that apply to the SNPNs as discussed above.

In one or more aspects, upon receiving the mobility restriction list 610, the first NG-RAN 604 may determine, based on the mobility restriction list, a mobility action for a UE that is connected to the first NG-RAN node 604. In one or more aspects, the mobility action can be a subsequent mobility action for the UE. For example, the mobility action determined by the first NG-RAN 604 (e.g., subsequent mobility action for the UE) can be a handover operation, a SCG selection during dual connectivity procedure, etc. In the case of a handover operation, when multiple SNPN IDs are broadcasted in a cell selected by NG-RAN 604, the source NG-RAN (e.g., first NG-RAN 604) may select a target SNPN for the handover operation, taking into account the list of equivalent SNPNs in the mobility restriction list 610 received from the AMF 602 or second NG-RAN 606. For instance, NG-RAN 604 may select the target SNPN for handing over the UE based on or taking into account the list of SNPN IDs, identifying the equivalent SNPNs, which are equivalent to the serving SNPN. That is, besides the measurement report from the UE that includes the signal strengths of the serving and neighbouring cells, NG-RAN 604 may also take into account the list of equivalent SNPNs that are equivalent to the serving SNPN when selecting target SNPN for the handover of the UE.

In one or more aspects, the handover operation can be Xn-based handover operation between a source NG-RAN (e.g., first NG-RAN 604) and a target NG-RAN (e.g., third NG-RAN 608). In such a case, the source/first NG-RAN 604 may indicate the selected SNPN to the target/third NG-RAN 608. For example, the first NG-RAN 604 may indicate the selected SNPN ID to the third NG-RAN 608 via a handover request message 630 that is transmitted from the former to the latter via an Xn interface. The handover request message 630 may be a message sent by a source NG-RAN node (e.g., first NG-RAN 604) to a target NG-RAN node (e.g., third NG-RAN 608) to request the preparation of resources for a handover of the UE from the source SNPN to the target or selected SNPN. In some aspects, the first NG-RAN 604 may receive a handover request acknowledge message from the third NG-RAN 608 if the latter admits the handover of the UE to the selected SNPN. A change in serving SNPN is indicated to the UE as part of the UE registration with the selected network.

In one or more aspects, the handover operation can be X2 or NGAP-based handover operation between a source NG-RAN (e.g., first NG-RAN 604) and an AFM of a core network (e.g., AFM 602). In such a case, the source/first NG-RAN 604 may indicate the selected SNPN to the AFM 602. For example, the first NG-RAN 604 may indicate the selected SNPN ID to the AFM 602 via a handover required message 640 that is transmitted from the former to the latter via an N2 or NGAP interface. The handover required message 640 may be a message sent by a source NG-RAN node (e.g., first NG-RAN 604) to a AMF (e.g., AMF 602) to request the preparation of resources at the target for a handover of the UE from the source SNPN to the target or selected SNPN.

In one or more aspects, the first NG-RAN 604 indicates the selected SNPN ID to the AMF 602 together with a tracking area identity (TAI) sent in the handover required message. The source AMF 602 may use the selected SNPN ID together with the TAI information supplied by the first NG-RAN 604 to select the target AMF. The source AMF 602 should forward the selected SNPN ID to the target AMF. The target AMF indicates the selected SNPN ID to the target NG-RAN so that the target NG-RAN can select target cells for future handover appropriately. A change in serving SNPN is indicated to the UE as part of the UE registration with the selected network.

As mentioned above, in one or more aspects, the mobility action (e.g., subsequent mobility action for the UE) can be a SCG selection during dual connectivity procedure. A dual connectivity procedure can be used to add, modify and releases resources for the operation of dual connectivity for the UE, and the procedure may be supported by Xn interfaces. In one or more aspects, the master NG-RAN (M-NG-RAN) node of the dual connectivity procedure may indicate the selected SNPN ID to the secondary NG-RAN (S-NG RAN) node of the dual connectivity procedure. For example, a first NG-RAN 604 node, acting as an M-NG-RAN node, may initiate the secondary node (s-node) addition or modification preparation procedure with a third NG-RAN 608 node, acting as an S-NG-RAN, by sending the third NG-RAN 608 an s-node addition or modification request message 650. In one or more aspects, the s-node addition or modification request message 650 may include the selected SNPN ID, and the S-NG RAN or third NG-RAN 608 may utilize the received SNPN ID for radio resource management (RRM) purposes such as but not limited to efficient energy usage, higher throughput, lower delays, and decreased packet loss.

Another SNPN operational principle that facilitates UE access to a SNPN, as well as UE mobility between SNPNs, may be support for non-3GPP access for SNPNs. The 5G core network (5GCN) supports both untrusted access via untrusted non-3GPP access networks and trusted access via trusted non-3GPP access networks (TNANs). Untrusted access refers to the fact that the mobile network operator (MNO) may not trust the security offered by the non-3GPP access network, whereas trusted access refers to the fact that the operator has full control of the trusted non-3GPP access point (TNAP) and the radio link access (e.g., and as such has trust in the security offered by the non-3GPP access network). An untrusted non-3GPP access network can connect to the 5G Core Network via a N3IWF, whereas a trusted non-3GPP access network can connect to the 5GCN via a TNGF. Both the N3IWF and the TNGF interface with the 5GCN control plane and user plane functions via the N2 and N3 interfaces, respectively. TNAN can be implemented as trusted wireless local area network (WLAN) access network (TWAN) that, in this case, only supports WLAN. TWAN includes trusted WLAN access point (TWAP) and TWIF to provide trusted connection to 5GCN for UEs in a WLAN with no 5G capabilities. Another type of non-3GPP access to 5GCN is wireline access where a gateway function called wireline access gateway function (W-AGF) connects the wireline access networks to the 5GCN. The non-3GPP access network nodes, i.e., N3IWF, TNGF, TWIF, and/or W-AGF may communicate with the AMF of the 5GCN using NGAP.

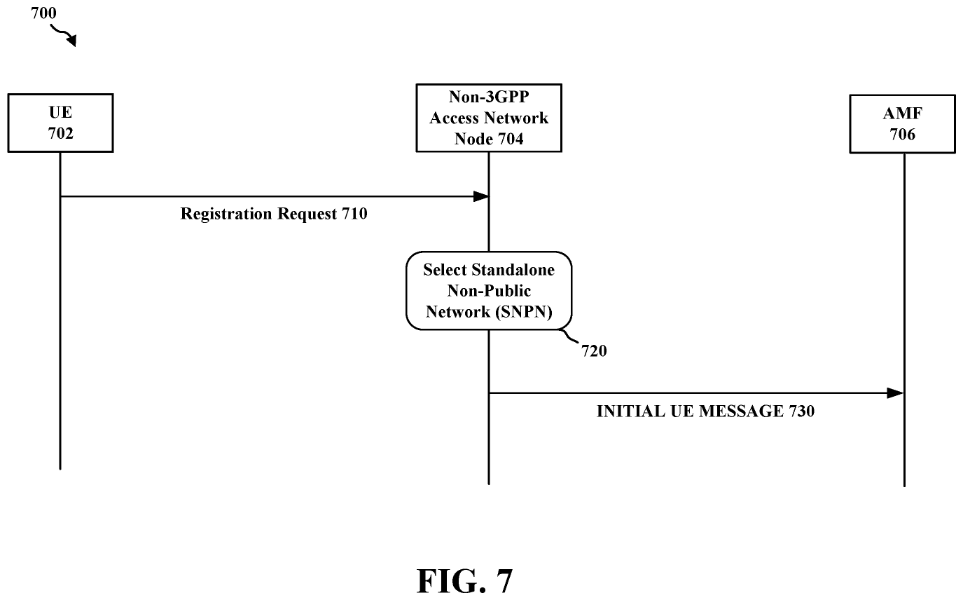

FIG. 7 shows a signaling diagram illustrating an example communication between a non-3GPP access network node, a UE, and an AMF in accordance with one or more aspects of the present disclosure. In one or more aspects, a UE 702 may transmit to the non-3GPP access network node 704 a registration request 710 for registering the UE with the 5GCN. For example, the UE 702 may at first use an access network discovery and selection policy (ANDSP) to discover and prioritize non-3GPP access networks and select a non-3GPP access network node 704, and transmit the registration request 710 thereto. For instance, the UE 702 may use a WLAN selection policy (WLANSP) for a specified Wi-Fi network and selection of N3IWF in PLMN, and for obtaining an IP address. The UE 702 may then send the registration request 710 to the non-3GPP access network node 704 via the IP address.

In one or more aspects, to provide the UE 702 access to a SNPN, the non-3GPP access network node 704 may select, at step 720, a SNPN. For example, the SNPN may be identified by a SNPN ID that may include a PLMN identifier (ID) or a network identifier (NID), or both. That is, in some aspects, the selected SNPN may be identifiable by its selected SNPN ID and/or selected NID. In one or more aspects, the non-3GPP access network node 704 may generate and transmit to the AMF 706 of the 5GCN an initial UE message 730 using a NGAP used for control communication between the non-3GPP access network node 704 and the AMF 706 of the 5GCN (e.g., over an N2 interface). The initial UE message 730 may include the registration request 710 from the UE, or information extracted therefrom, and may be configured to inform the 5GCN that the UE 702 requests to enter the 5GCN and access the selected SNPN (e.g., identified by selected NID). For example, the initial UE message 730 may also include the identifier of the selected SNPN, e.g., selected NID.

Table 2 below shows an example initial UE message 730 that may be transmitted by the non-3GPP access network node 704 to the AMF 706 of the 5GCN via NGAP to inform the 5GCN that the UE 702 requests or wishes to obtain access to the SNPN identified by the selected NID. In one or more aspects, the initial UE message 730 may be generated by modifying the form of a NAS transport message (e.g., an initial UE message) that is sent by NG-RANs to AMFs over NG interfaces to transfer initial layer 3 messages received from UEs. An example modification to the NAS initial UE message is the addition of an information element (IE) indicating the selected NID into the NAS initial UE message, emphasized with an underline in Table 2. That is, a new “Selected NID” IE may be defined and included in the initial UE message 730 to indicate to the 5GCN the SNPN that the UE 702 may connect to.

TABLE 2
Initial UE message

| | | | | | | |
|---|---|---|---|---|---|---|
| IE/Group | | | IE type and | | | Assigned |
| Name | Presence | Range | reference | Semantics description | Criticality | Criticality |

| | | | | | |
|---|---|---|---|---|---|
| Message | M | 9.3.1.1 | | YES | ignore |
| Type | | | | | |
| RAN UE | M | 9.3.3.2 | | YES | reject |
| NGAP ID | | | | | |
| NAS-PDU | M | 9.3.3.4 | | YES | reject |
| User Location | M | 9.3.1.16 | | YES | reject |
| Information | | | | | |
| RRC | M | 9.3.1.111 | | YES | ignore |
| Establishment | | | | | |
| Cause | | | | | |
| 5G-S-TMSI | O | 9.3.3.20 | | YES | reject |
| AMF Set ID | O | 9.3.3.12 | | YES | ignore |
| UE Context | O | ENUMERATED | | YES | ignore |
| Request | | (requested, . . .) | | | |
| Allowed | O | 9.3.1.31 | | YES | reject |
| NSSAI | | | | | |
| Source to | O | 9.3.3.27 | | YES | ignore |
| Target AMF | | | | | |
| Information | | | | | |
| Reroute | | | | | |
| Selected | O | PLMN Identity | Indicates the selected PLMN | YES | ignore |
| PLMN | | 9.3.3.5 | id for the non-3GPP access. | | |
| Identity | | | | | |
| Selected NID | O | | | | |
| IAB Node | O | ENUMERATED | Indication of an IAB node | YES | reject |
| Indication | | (true, . . .) | | | |
| CE-mode-B | O | 9.3.1.156 | | YES | reject |
| Support | | | | | |
| Indicator | | | | | |
| LTE-M | O | 9.3.1.157 | | YES | ignore |
| Indication | | | | | |
| EDT Session | O | ENUMERATED | | YES | ignore |
| | | (true, . . .) | | | |
| Authenticated | O | ENUMERATED | Indicates the FN-RG has been | YES | ignore |
| Indication | | (true, . . .) | authenticated by the access network. | | |
| NPN Access | O | 9.3.3.46 | | YES | reject |
| Information | | | | | |
| RedCap | O | 9.3.1.228 | | YES | ignore |
| Indication | | | | | |

In one or more aspects, instead of or in addition to defining, and including in the initial UE message 730, a “Selected NID” IE as shown in Table 2, the selected NID may be included in the “User Location Information” IE that is also located in the initial UE message 730 and is used to provide location information of the UE. A user location information IE in NGAP messages includes the following IEs: IP address IE and port number IE for the untrusted non-3GPP access; TNGF user location information IE for the trusted non-3GPP access; TWIF user location information IE for the trusted WLAN access; and W-AGF user location information IE for the wireline 5G access. The initial UE message 730 may then be made to include the selected NID by modifying one or more of the non-3GPP access network node user location information IEs in the user location information IE. For example, Table 3 shows an example user location information IE where the selected NID is included as an “IE/Group Name” item entry under N3IWF user location information IE and TNGF user location information IE, emphasized with underlines. In one or more aspects, the selected NID may be included or listed as an “IE/Group Name” item entry under N3IWF user location information IE and/or TNGF user location information IE.

TABLE 3
User Location Information

| | | | | | | |
|---|---|---|---|---|---|---|
| | | | IE type and | | | Assigned |
| IE/Group Name | Presence | Range | reference | Semantics description | Criticality | Criticality |

| | | | | | |
|---|---|---|---|---|---|
| CHOICE User | M | | | — | |
| Location Information | | | | | |
| >E-UTRA user | | | | | |
| location information | | | | | |
| >>E-UTRA CGI | M | 9.3.1.9 | | — | |
| >>TAI | M | 9.3.3.11 | | — | |
| >>Age of Location | O | Time Stamp | Indicates the UTC time when the location | — | |
| | | 9.3.1.75 | information was generated. | | |
| >>PSCell Information | O | NG-RAN CGI | | YES | ignore |
| | | 9.3.1.73 | | | |
| >NR user location | | | | | |
| information | | | | | |
| >>NR CGI | M | 9.3.1.7 | | — | |
| >>TAI | M | 9.3.3.11 | This IE is ignored if the NR NTN TAI | — | |
| | | | Information IE is present. | | |
| >>Age of Location | O | Time Stamp | Indicates the UTC time when the location | — | |
| | | 9.3.1.75 | information was generated. | | |
| >>PSCell Information | O | NG-RAN CGI | | YES | ignore |
| | | 9.3.1.73 | | | |
| >>NID | O | 9.3.3.42 | | YES | reject |
| >>NR NTN TAI | O | 9.3.3.53 | | YES | ignore |
| Information | | | | | |
| >N3IWF user | | | | | |
| location information | | | | | |
| >>IP Address | M | Transport | UE's local IP address used to reach the | — | |
| | | Layer Address | N3IWF | | |
| | | 9.3.2.4 | | | |
| >>Port Number | O | OCTET | UDP or TCP source port number if NAT | — | |
| | | STRING | is detected. | | |
| | | (SIZE(2)) | | | |
| >>Selected NID | O | | | | |
| >TNGF user | | | | YES | ignore |
| location information | | | | | |
| >>TNAP ID | M | OCTET | TNAP Identifier used to identify the | — | |
| | | STRING | TNAP. Details in TS 29.571 [35]. | | |
| >>IP Address | M | Transport | UE's local IP address used to reach | — | |
| | | Layer Address | the TNGF. | | |
| | | 9.3.2.4 | | | |
| >>Port Number | O | OCTET | UDP or TCP source port number if NAT | — | |
| | | STRING | is detected. | | |
| | | (SIZE(2)) | | | |
| >>Selected NID | O | | | | |
| >TWIF user | | | | YES | ignore |
| location information | | | | | |
| >>TWAP ID | M | OCTET | TWAP Identifier used to identify the | — | |
| | | STRING | TWAP. Details in TS 29.571 [35]. | | |
| >>IP Address | M | Transport | Non-5G-Capable over WLAN device's local | — | |
| | | Layer Address | IP address used to reach the TWIF. | | |
| | | 9.3.2.4 | | | |
| >>Port Number | O | OCTET | UDP or TCP source port number if NAT | — | |
| | | STRING | is detected. | | |
| | | (SIZE(2)) | | | |
| >W-AGF user | | | Indicates the location information via | YES | ignore |
| location information | | | wireline access as specified in | | |
| | | | TS 23.316 [34]. | | |
| >>W-AGF user | M | 9.3.1.164 | | — | |
| location information | | | | | |

In one or more aspects, once the AMF 706 of the 5GCN receives the initial UE message 730 transmitted by the non-3GPP access network node 704 via NGAP (e.g., over an N2 interface), the 5GCN may allow the UE 702 to access, via the non-3GPP access network node 704, the SNPN identified by the NID included in the initial UE message 730, effecting non-3GPP access to a SNPN by a UE.

Another SNPN operational principle that facilitates UE access to a SNPN, as well as UE mobility between SNPNs, may be support for providing access to localized services (PALS) related to non-public networks. A localized service can be a 5G network access that is localized in space (e.g., geographic locations, list of cells/tracking areas, etc.) and/or time, i.e., the access may be provided over a limited area and/or can be bounded in time. The localized service may be provided by a localized service provider, such as an application provider or network operator that offer the localized service to end users via a hosting network, which can be can be a SNPN or a PNI-NPN. Localized services provide new opportunities for users and service providers, in particular at locations where no coverage is provided by other networks. Examples of such scenarios include cargo ships at sea, short-term events at stadiums, concert venues, etc.

In one or more aspects, when the hosting network is a PNI-NPN, the location validity of a localized service (i.e., the location (e.g., geographic locations, list of cells/tracking areas, etc.) over which a 5G network access is available) and/or the time validity of the localized service (i.e., the time during which 5G network access is available) may be handled by the AMF of the 5GCN implicitly. For example, the AMF may update a mobility restriction list (e.g., similar to the one shown in Table 1) to restrict access of a UE to a 5G network after the time validity of the localized service expires. As discussed above, PNI-NPNs are identified by PLMN IDs and/or CAG IDs, and the AMF may update the mobility restriction list to prevent UEs from accessing PNI-NPNs via associated cells of the CAGs once the time validity of a localized service expires.

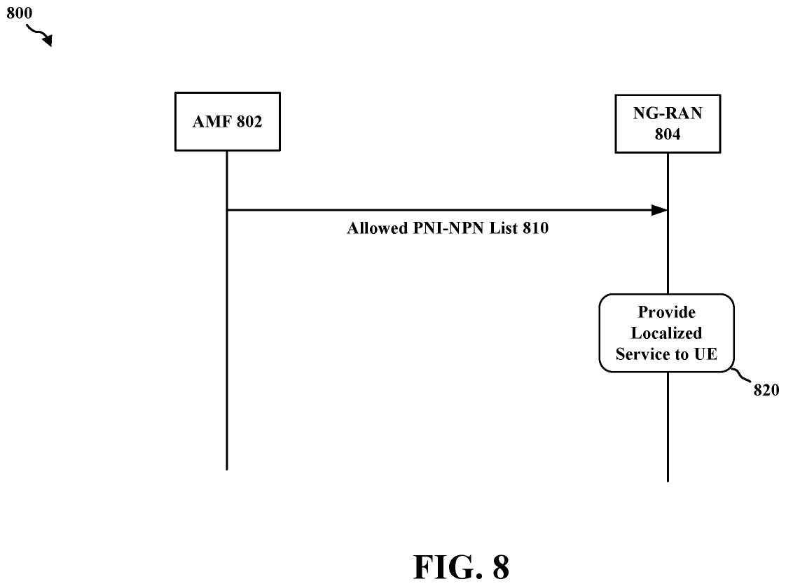

In one or more aspects, a AMF handle the location validity and/or time validity of a localized service explicitly. FIG. 8 is a signaling diagram illustrating an example communication between an AMF of a CN and a NG-RAN node in accordance with one or more aspects of the present disclosure. In one or more aspects, the AMF 802 of the 5GCN may generate and transmit to a NG-RAN 804 an allowed PNI-NPN list 810 that includes one or both of the time validity information and the location validity information for localized services. An allowed PNI-NPN list contains information on allowed UE mobility in PNI-NPN including allowed PNI-NPNs and whether the UE is allowed to access non-CAG cells for each PLMN. Table 4 shows an example “allowed PNI-NPN list” that is modified to include the time validity information and the location validity information for localized services, emphasized with underlines. One or both of the time validity information and the location validity information for localized services may be included in the allowed PNI-NPN list 810 as item entries under “allowed CAG List per PLMN” IE.

TABLE 4
Allowed PNI-NPN List

| IE/Group | | | IE type and | Semantics |
|---|---|---|---|---|
| Name | Presence | Range | reference | description |
| Allowed | | 1 . . . <maxnoofEPLMNs + 1> | | |
| PNI-NPN | | | | |
| Item | | | | |
| >PLMN | M | | 9.3.3.5 | |
| Identity | | | | |
| >PNI-NPN | M | | ENUMERATED | If set to |
| Restricted | | | (restricted, not- | “restricted”, |
| | | | restricted, . . .) | indicates |
| | | | | that the UE |
| | | | | is not allowed |
| | | | | to access non- |
| | | | | CAG cells for |
| | | | | this PLMN. |
| >Allowed | | 1 . . . <maxnoofAllowedCAGsperPLMN> | | |
| CAG List | | | | |
| per PLMN | | | | |
| >>CAG ID | M | | 9.3.3.43 | |
| >> Time | O | | | |
| validity | | | | |
| information | | | | |
| for localized | | | | |
| services | | | | |
| >> Location | O | | | |
| validity | | | | |
| information | | | | |
| for localized | | | | |
| services | | | | |

Upon receiving the allowed PNI-NPN list 810, in one or more aspects, the NG-RAN 804 may provide, at step 820, a UE access to the localized service via the PNI-NPN hosting network.

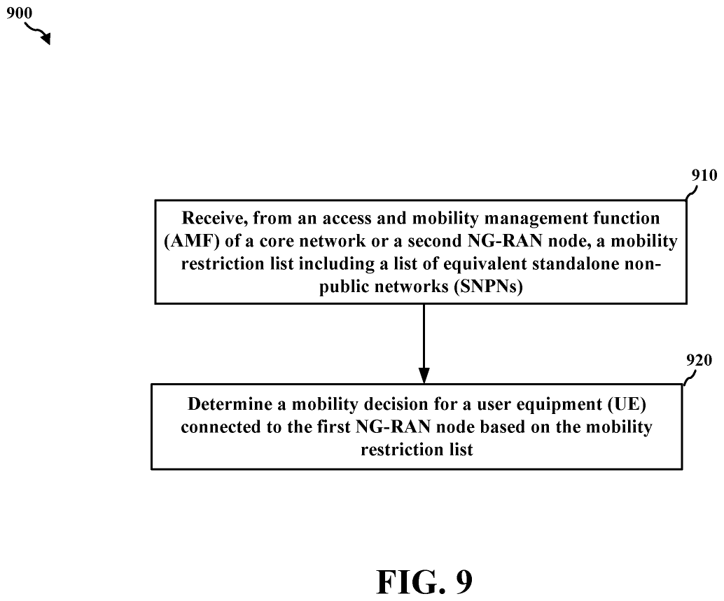

FIG. 9 is a flowchart of a method 900 of wireless communication for providing a UE access to a non-public network, and facilitating the mobility of a UE between non-public networks. The method may be performed by a base station or an NG-RAN, or a component thereof. For example, aspects of method 900 may be performed by NG-RAN 102, 205, 305a-b, 405a-b, 604, 804, 1300, and/or the like.

At block 910, a first NG-RAN may receive, from an access and mobility management function (AMF) of a core network or a second NG-RAN node, a mobility restriction list including a list of equivalent standalone non-public networks (SNPNs). In one or more aspects, the mobility restriction list includes one or more restrictions that apply to the list of equivalent SNPNs. The mobility restriction list also includes a list of equivalent public land mobile networks (PLMNs) and the one or more restrictions may also apply to the list of equivalent PLMNs. In one or more aspects, the one or more restrictions are dedicated to the list of equivalent SNPNs and do not apply to any list of equivalent PLMNs. In one or more aspects, the one or more restrictions include radio access technology (RAT) restriction, forbidden area restriction, and/or service area restriction.

At block 920, the first NG-RAN may determine a mobility action for a user equipment (UE) connected to the first NG-RAN node based on the mobility restriction list. In some aspects, the mobility action can be a handover operation of the UE from one SNPN to another SNPN. For example, in one or more aspects, the first NG-RAN may receive a broadcast message indicating a list of SNPN IDs identifying candidate SNPNs for use in performing a handover operation of the UE from a source SNPN to a target SNPN. In such cases, the first NG-RAN may determine the mobility action for the UE by selecting the target SNPN from the candidate SNPNs based at least in part on the list of equivalent SNPNs of the mobility restriction list.

In one or more aspects, the first NG-RAN may be configured to transmit to the AMF a handover required message including a SNPN ID of the list of SNPN IDs that identifies the target SNPN. Further, the first NG-RAN may be configured to transmit to a third NG-RAN node a handover request message including the SNPN ID of the list of SNPN IDs that identifies the target SNPN. In addition, the first NG-RAN may be configured to transmit to a fourth NG-RAN node, a secondary node (s-node) addition request message including a SNPN ID of the list of SNPN IDs that identifies the target SNPN.

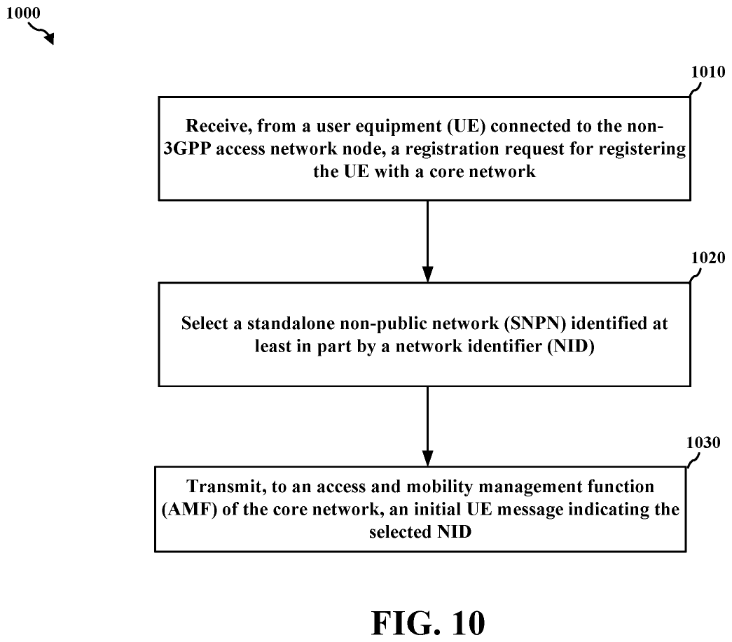

FIG. 10 is a flowchart of a method 1000 of wireless communication for providing a UE access to a non-public network, and facilitating the mobility of a UE between non-public networks. The method 1000 may be performed by a non-3GPP access network node (e.g., N3IWF, TNGF), or a component thereof. For example, aspects of method 1000 may be performed by N3IWF 235, N3ANN 335, non-3GPP access network node (N3ANN) 435, non-3GPP access network node 704, and/or the like.

At block 1010, the N3ANN receives, from a user equipment (UE) connected to the N3ANN, a registration request for registering the UE with a core network. In one or more aspects, the non-3GPP access network node is a N3IWF. In one or more aspects, the non-3GPP access network node is a TNGF.

At block 1020, the N3ANN selects a standalone non-public network (SNPN) identified at least in part by a selected network identifier (NID).

At block 1030, the N3ANN transmits, to an access and mobility management function (AMF) of the core network, an initial UE message indicating the selected NID. In one or more aspects, the initial UE message includes an information element (IE) indicating the selected NID. In one or more aspects, the initial UE message includes an IE indicating user location information, the IE including a non-3GPP access network node user location information indicating the selected NID.

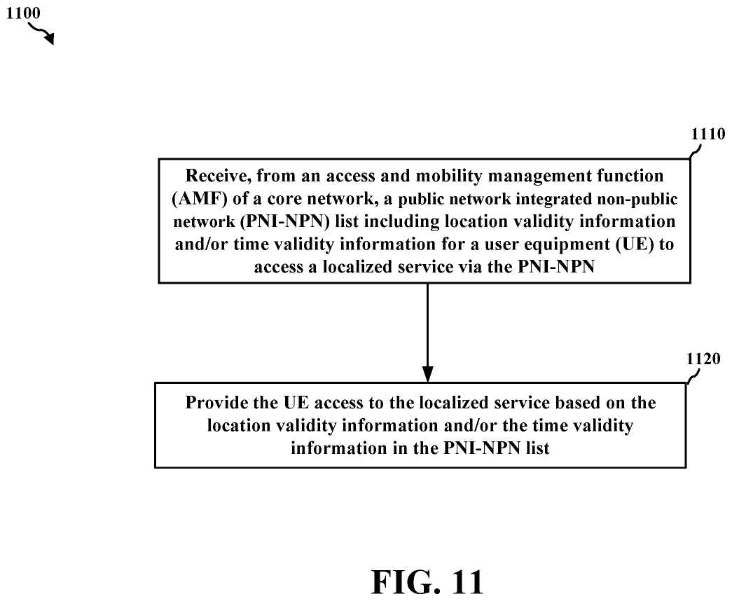

FIG. 11 is a flowchart of a method 1100 of wireless communication for providing a UE access to a non-public network, and facilitating the mobility of a UE between non-public networks. The method 1100 may be performed by a base station or an NG-RAN of a public network integrated non-public network (PNI-NPN), or a component thereof. For example, aspects of method 900 may be performed by NG-RAN 102, 205, 305a-b, 405a-b, 604, 606, 608, 804, 1300, and/or the like, when the NG-RAN belongs to a PNI-NPN.

At block 1110, the NG-RAN of a PNI-NPN receives, from an access and mobility management function (AMF) of a core network, an allowed PNI-NPN list including location validity information and/or time validity information for a user equipment (UE) to access a localized service via the PNI-NPN. In one or more aspects, the location validity information includes a geographical location where the PNI-NPN is available. In one or more aspects, the location validity information includes a list of tracking areas of the PNI-NPN.

At block 1120, the NG-RAN provides the UE access to the localized service based on the location validity information and/or the time validity information in the allowed PNI-NPN list.

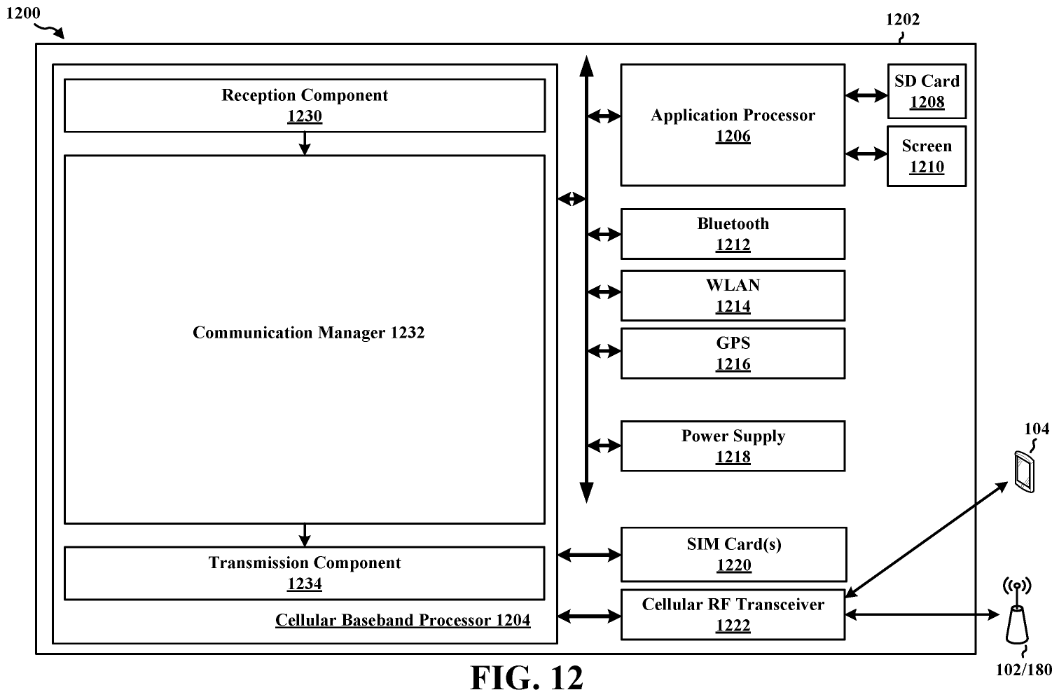

FIG. 12 is a diagram 1200 illustrating an example of a hardware implementation for an apparatus 1202. The apparatus 1202 may be a UE, a component of a UE, or may implement UE functionality. In some aspects, the UE 1202 may include a cellular baseband processor 1204 (also referred to as a modem) coupled to a cellular RF transceiver 1222. In some aspects, the UE 1202 may further include one or more subscriber identity modules (SIM) cards 1220, an application processor 1206 coupled to a secure digital (SD) card 1208 and a screen 1210, a Bluetooth module 1212, a wireless local area network (WLAN) module 1214, a Global Positioning System (GPS) module 1216, or a power supply 1218. The cellular baseband processor 1204 communicates through the cellular RF transceiver 1222 with the UE 104 and/or BS 102/180. The cellular baseband processor 1204 may include a computer-readable medium/memory. The computer-readable medium/memory may be non-transitory. The cellular baseband processor 1204 is responsible for general processing, including the execution of software stored on the computer-readable medium/memory. The software, when executed by the cellular baseband processor 1204, causes the cellular baseband processor 1204 to perform the various functions described supra. The computer-readable medium/memory may also be used for storing data that is manipulated by the cellular baseband processor 1204 when executing software. The cellular baseband processor 1204 further includes a reception component 1230, a communication manager 1232, and a transmission component 1234. The communication manager 1232 includes the one or more illustrated components. The components within the communication manager 1232 may be stored in the computer-readable medium/memory and/or configured as hardware within the cellular baseband processor 1204. The cellular baseband processor 1204 may be a component of the UE 550 and may include the memory 560 and/or at least one of the TX processor 568, the RX processor 556, and the controller/processor 559. In one configuration, the UE component 1202 may be a modem chip and include just the baseband processor 1204. and in another configuration, the apparatus 1202 may be the entire UE (e.g., see 550 of FIG. 5) and include the additional modules of the UE 1202.

The UE 1202 may include additional components that perform one or more of the blocks of the algorithm in the flowcharts of FIGS. 9-11. As such, these one or more blocks in the flowcharts of FIGS. 9-11 may be performed by a component and the UE may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the UE 1202 may include a variety of components configured for various functions. In some configurations, the UE 1202, and in particular the cellular baseband processor 1204, may include means for performing the functionalities discussed with reference to UE 104, 204, 304, 404, 550, and 702. As described supra, the UE 1302 may include the TX Processor 368, the RX Processor 356, and the controller/processor 359. As such, in one configuration, the means may be the TX Processor 368, the RX Processor 356, and the controller/processor 359 configured to perform the functions recited by the means. For example, the UE 1202 may include a means for transmitting to a non-3GPP access network node, a registration request for registering the UE with a core network, as described above with reference to step 710 of FIG. 7 and/or block 1010 of FIG. 10. Then, the means may be the TX Processor 368 and the controller/processor 359 configured to perform the function recited by the means.

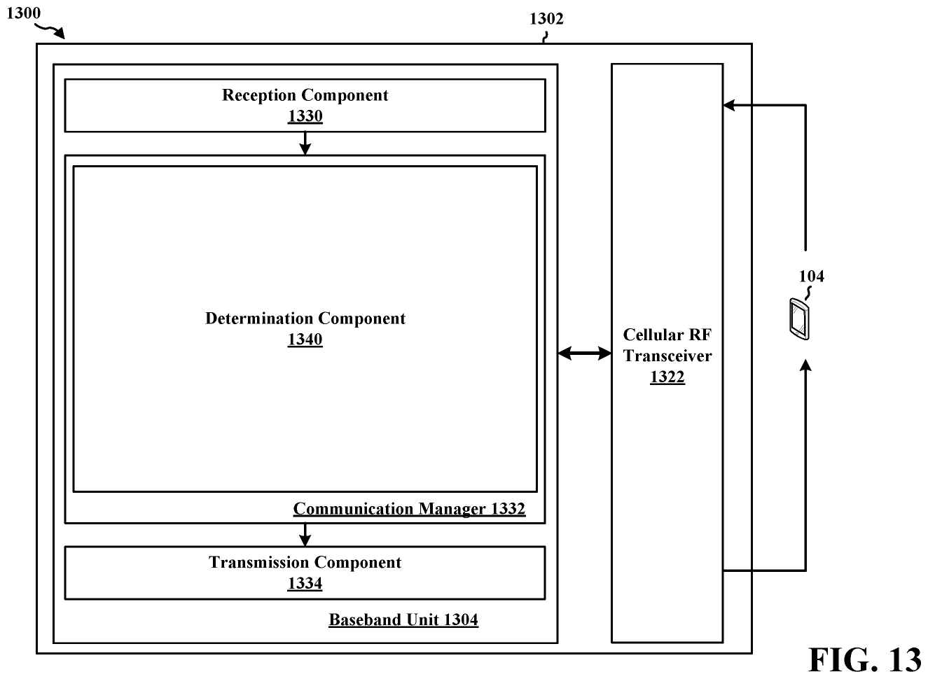

FIG. 13 is a diagram 1300 illustrating an example of a hardware implementation for an apparatus 1302. The apparatus 1302 may be a base station or a NG-RAN, a component thereof, or may implement base station/NG-RAN functionality. In some aspects, the NG-RAN 1302 may include a baseband unit 1304. The baseband unit 1304 may communicate through a cellular RF transceiver 1322 with the UE 104. The baseband unit 1304 may include a computer-readable medium/memory. The baseband unit 1304 is responsible for general processing, including the execution of software stored on the computer-readable medium/memory. The software, when executed by the baseband unit 1304, causes the baseband unit 1304 to perform the various functions described supra. The computer-readable medium/memory may also be used for storing data that is manipulated by the baseband unit 1304 when executing software. The baseband unit 1304 further includes a reception component 1330, a communication manager 1332, and a transmission component 1334. The communication manager 1332 includes the one or more illustrated components. The components within the communication manager 1332 may be stored in the computer-readable medium/memory and/or configured as hardware within the baseband unit 1304. The baseband unit 1304 may be a component of the base station/NG-RAN 510 and may include the memory 576 and/or at least one of the TX processor 516, the RX processor 570, and the controller/processor 575.

The communication manager 1332 includes a determination component 1340 that is configured to determine a mobility action for a user equipment (UE) connected to the first NG-RAN node based on a mobility restriction list that is received from an access and mobility management function (AMF) of a core network or a second NG-RAN node, e.g., as described with reference to step 620 of FIG. 6 and/or block 920 of FIG. 9. The mobility restriction list may include a list of equivalent standalone non-public networks (SNPNs). The determination component 1340 may also be configured to provide the UE access to a localized service based on location validity information and/or time validity information in an allowed PNI-NPN list received from an AMF of a core network, as described above with reference to step 820 of FIG. 8 and/or block 1120 of FIG. 11.

The NR-RAN 1302 may include additional components that perform one or more blocks of the algorithm in the flowcharts of FIGS. 9-11. As such, these one or more blocks in the flowcharts of FIGS. 9-11 may be performed by a component and the NG-RAN may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the NR-RAN 1302 may include a variety of components configured for various functions. In one configuration, the NR-RAN 1302, and in particular the baseband unit 1304, includes means for receiving, from an access and mobility management function (AMF) of a core network or a second NG-RAN node, a mobility restriction list including a list of equivalent standalone non-public networks (SNPNs); means for determining a mobility action for a user equipment (UE) connected to the first NG-RAN node based on the mobility restriction list; means for receiving, from an AMF of a core network, a public network integrated non-public network (PNI-NPN) list including location validity information and/or time validity information for a UE to access a localized service via the PNI-NPN; and means for providing the UE access to the localized service based on the location validity information and/or the time validity information in the PNI-NPN list. The means may be one or more of the components of the NG-RAN 1302 configured to perform the functions recited by the means. As described supra, the NG-RAN 1302 may include the TX Processor 516, the RX Processor 570, and the controller/processor 575. As such, in one configuration, the means may be the TX Processor 516, the RX Processor 570, and the controller/processor 575 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C. B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following aspects are illustrative only and may be combined with other aspects or teachings described herein, without limitation.

Aspect 1 is a method for wireless communication performed by a first next generation radio access network (NG-RAN) node, comprising: receiving, from an access and mobility management function (AMF) of a core network or a second NG-RAN node, a mobility restriction list including a list of equivalent standalone non-public networks (SNPNs); and determining a mobility action for a user equipment (UE) connected to the first NG-RAN node based on the mobility restriction list.

Aspect 2 is the method of aspect 1, wherein the mobility restriction list includes one or more restrictions that apply to the list of equivalent SNPNs.

Aspect 3 is the method of aspect 2, wherein the mobility restriction list includes a list of equivalent public land mobile networks (PLMNs) and the one or more restrictions also apply to the list of equivalent PLMNs.

Aspect 4 is the method of aspect 2 or 3, wherein the one or more restrictions are dedicated to the list of equivalent SNPNs and do not apply to any list of equivalent PLMNs.

Aspect 5 is the method of any of aspects 2-4, wherein the one or more restrictions include radio access technology (RAT) restriction.

Aspect 6 is the method of any of aspects 2-5, wherein the one or more restrictions include forbidden area restriction.

Aspect 7 is the method of any of aspects 2-6, wherein the one or more restrictions include service area restriction.

Aspect 8 is the method of any of aspects 1-7, further comprising: receiving a broadcast message indicating a list of SNPN IDs identifying candidate SNPNs for use in performing a handover operation of the UE from a source SNPN to a target SNPN, wherein: the determining includes selecting the target SNPN from the candidate SNPNs based at least in part on the list of equivalent SNPNs of the mobility restriction list.

Aspect 9 is the method of aspect 8, further comprising transmitting, to the AMF, a handover required message including a SNPN ID of the list of SNPN IDs that identifies the target SNPN.

Aspect 10 is the method of aspect 8 or 9, further comprising transmitting, to a third NG-RAN node, a handover request message including a SNPN ID of the list of SNPN IDs that identifies the target SNPN.

Aspect 11 is the method of any of aspects 8-10, further comprising transmitting, to a third NG-RAN node, a secondary node (s-node) addition request message including a SNPN ID of the list of SNPN IDs that identifies the target SNPN.

Aspect 12 is the method of any of aspects 1-11, wherein the mobility action for the UE includes a handover operation for the UE or a secondary cell group (SCG) selection for the UE during a dual connectivity procedure.

Aspect 13 is a method for wireless communication performed by a non-3GPP access network node, comprising: receiving, from a user equipment (UE) connected to the non-3GPP access network node, a registration request for registering the UE with a core network; selecting a standalone non-public network (SNPN) identified at least in part by a selected network identifier (NID); transmitting, to an access and mobility management function (AMF) of the core network, an initial UE message indicating the selected NID.

Aspect 14 is the method of aspect 13, wherein the initial UE message includes an information element (IE) indicating the selected NID.

Aspect 15 is the method of aspect 13 or 14, wherein the initial UE message includes an IE indicating user location information, the IE including a non-3GPP access network node user location information indicating the selected NID.

Aspect 16 is the method of any of aspects 13-15, wherein the non-3GPP access network node is a Non-3GPP InterWorking Function (N3IWF).

Aspect 17 is the method of any of aspects 13-16, wherein the non-3GPP access network node is a Trusted Non-3GPP Gateway Function (TNGF).

Aspect 18 is a method for wireless communication performed by a next generation radio access network (NG-RAN) node of a public network integrated non-public network (PNI-NPN), comprising: receiving, from an access and mobility management function (AMF) of a core network, an allowed PNI-NPN list including location validity information and/or time validity information for a user equipment (UE) to access a localized service via the PNI-NPN; and providing the UE access to the localized service based on the location validity information and/or the time validity information in the allowed PNI-NPN list.

Aspect 19 is the method of aspect 18, wherein the location validity information includes a geographical location where the PNI-NPN is available.

Aspect 20 is the method of aspect 18 or 19, wherein the location validity information includes a list of tracking areas of the PNI-NPN.

Aspect 21 is a first next generation radio access network (NG-RAN) node comprising a memory storing processor-readable code; and at least one processor coupled to the memory, the at least one processor configured to execute the processor-readable code to cause the at least one processor to implement any of aspects 1-12.

Aspect 22 is a non-3GPP access network node comprising a memory storing processor-readable code; and at least one processor coupled to the memory, the at least one processor configured to execute the processor-readable code to cause the at least one processor to implement any of aspects 13-17.

Aspect 23 is a first next generation radio access network (NG-RAN) node comprising a memory storing processor-readable code; and at least one processor coupled to the memory, the at least one processor configured to execute the processor-readable code to cause the at least one processor to implement any of aspects 18-20.

Aspect 24 is an NG-RAN node for wireless communication including means for implementing any of aspects 1 to 12.

Aspect 25 is a non-3GPP access network node for wireless communication including means for implementing any of aspects 13 to 17.

Aspect 26 is an NG-RAN node for wireless communication including means for implementing any of aspects 18 to 20.

Aspect 27 is a computer-readable medium storing computer executable code, where the code when executed by a processor causes the processor to implement any of aspects 1 to 20.

What is claimed is:

1. A first next generation radio access network (NG-RAN) node, comprising:
a memory storing processor-readable code; and
at least one processor coupled to the memory, the at least one processor configured to execute the processor-readable code to cause the at least one processor to:
receive, from an access and mobility management function (AMF) of a core network or a second NG-RAN node, a mobility restriction list including a list of equivalent standalone non-public networks (SNPNs); and
determine a mobility action for a user equipment (UE) connected to the first NG-RAN node based on the mobility restriction list.

2. The first NG-RAN node of claim 1, wherein the mobility restriction list includes one or more restrictions that apply to the list of equivalent SNPNs.

3. The first NG-RAN node of claim 2, wherein the mobility restriction list includes a list of equivalent public land mobile networks (PLMNs) and the one or more restrictions also apply to the list of equivalent PLMNs.

4. The first NG-RAN node of claim 2, wherein the one or more restrictions are dedicated to the list of equivalent SNPNs and do not apply to any list of equivalent PLMNs.

5. The first NG-RAN node of claim 2, wherein the one or more restrictions include a radio access technology (RAT) restriction, a forbidden area restriction, or a service area restriction.

6. The first NG-RAN node of claim 2, wherein the mobility action for the UE includes a handover operation for the UE.

7. The first NG-RAN node of claim 2, wherein the mobility action for the UE includes a secondary cell group (SCG) selection for the UE during a dual connectivity procedure.

8. The first NG-RAN node of claim 1, wherein the at least one processor is further configured to execute the processor-readable code to cause the at least one processor to:
receive a broadcast message indicating a list of SNPN IDs identifying candidate SNPNs for use in performing a handover operation of the UE from a source SNPN to a target SNPN, wherein:
the at least one processor determines the mobility action by selecting the target SNPN from the candidate SNPNs based at least in part on the list of equivalent SNPNs of the mobility restriction list.

9. The first NG-RAN of claim 8, wherein the at least one processor is further configured to execute the processor-readable code to cause the at least one processor to transmit, to the AMF, a handover required message including a SNPN ID of the list of SNPN IDs that identifies the target SNPN.

10. The first NG-RAN of claim 8, wherein the at least one processor is further configured to execute the processor-readable code to cause the at least one processor to transmit, to a third NG-RAN node, a handover request message including a SNPN ID of the list of SNPN IDs that identifies the target SNPN.

11. The first NG-RAN of claim 8, wherein the at least one processor is further configured to execute the processor-readable code to cause the at least one processor to transmit, to a third NG-RAN node, a secondary node (s-node) addition request message including a SNPN ID of the list of SNPN IDs that identifies the target SNPN.

12. A method for wireless communication performed by a first next generation radio access network (NG-RAN) node, comprising:
receiving, from an access and mobility management function (AMF) of a core network or a second NG-RAN node, a mobility restriction list including a list of equivalent standalone non-public networks (SNPNs); and
determining a mobility action for a user equipment (UE) connected to the first NG-RAN node based on the mobility restriction list.

13. The method of claim 12, wherein the mobility restriction list includes one or more restrictions that apply to the list of equivalent SNPNs.

14. The method of claim 13, wherein the mobility restriction list includes a list of equivalent public land mobile networks (PLMNs) and the one or more restrictions also apply to the list of equivalent PLMNs.

15. The method of claim 13, wherein the one or more restrictions are dedicated to the list of equivalent SNPNs and do not apply to any list of equivalent PLMNs.

16. The method of claim 13, wherein the one or more restrictions include a radio access technology (RAT) restriction.

17. The method of claim 13, wherein the one or more restrictions include a forbidden area restriction or a service area restriction.

18. The method of claim 12, wherein the mobility action for the UE includes a handover operation for the UE or a secondary cell group (SCG) selection for the UE during a dual connectivity procedure.

19. The method of claim 12, further comprising:
receiving a broadcast message indicating a list of SNPN IDs identifying candidate SNPNs for use in performing a handover operation of the UE from a source SNPN to a target SNPN, wherein:
the determining includes selecting the target SNPN from the candidate SNPNs based at least in part on the list of equivalent SNPNs of the mobility restriction list.

20. The method of claim 19, further comprising transmitting, to the AMF, a handover required message including a SNPN ID of the list of SNPN IDs that identifies the target SNPN.

21. The method of claim 19, further comprising transmitting, to a third NG-RAN node, a handover request message including a SNPN ID of the list of SNPN IDs that identifies the target SNPN.

22. The method of claim 19, further comprising transmitting, to a third NG-RAN node, a secondary node (s-node) addition request message including a SNPN ID of the list of SNPN IDs that identifies the target SNPN.

23. A method for wireless communication performed by a non-3GPP access network node, comprising:
receiving, from a user equipment (UE) connected to the non-3GPP access network node, a registration request for registering the UE with a core network;
selecting a standalone non-public network (SNPN) identified at least in part by a selected network identifier (NID); and
transmitting, to an access and mobility management function (AMF) of the core network, an initial UE message indicating the selected NID.

24. The method of claim 23, wherein the initial UE message includes an information element (IE) indicating the selected NID.

25. The method of claim 23, wherein the initial UE message includes an IE indicating user location information, the IE including a non-3GPP access network node user location information indicating the selected NID.

26. The method of claim 23, wherein the non-3GPP access network node is a Non-3GPP InterWorking Function (N3IWF).

27. The method of claim 23, wherein the non-3GPP access network node is a Trusted Non-3GPP Gateway Function (TNGF).

28. A method for wireless communication performed by a next generation radio access network (NG-RAN) node of a public network integrated non-public network (PNI-NPN), comprising:
receiving, from an access and mobility management function (AMF) of a core network, an allowed PNI-NPN list including location validity information and/or time validity information for a user equipment (UE) to access a localized service via the PNI-NPN; and
providing the UE access to the localized service based on the location validity information and/or the time validity information in the allowed PNI-NPN list.

29. The method of claim 28, wherein the location validity information includes a geographical location where the PNI-NPN is available.

30. The method of claim 28, wherein the location validity information includes a list of tracking areas of the PNI-NPN.
